(19) United States
(12) Patent Application Publication
(10) Pub. No.: US 2026/0189818 A1
(43) Pub. Date: Jul. 2, 2026

(54) PHOTODETECTOR AND ELECTRONIC APPARATUS

(71) Applicant: Sony Semiconductor Solutions Corporation, Kanagawa (JP)

(72) Inventors: Satoru Yoshida, Kanagawa (JP); Shohei Shimada, Kanagawa (JP); Tsukasa Kagaya, Kanagawa (JP); Kazuhiro Yoneda, Kanagawa (JP); Atsushi Toda, Kanagawa (JP)

(21) Appl. No.: 19/129,179

(22) PCT Filed: Nov. 1, 2023
(86) PCT No.: PCT/JP23/39486

§ 371 Date: May 12, 2025

(30) Foreign Application Priority Data
Nov. 30, 2022 (JP) 2022-192057

(51) Int. Cl. H04N 25/77; H04N 25/705; H04N 25/79

(52) U.S. Cl. CPC H04N 25/77; H04N 25/705; H04N 25/79

(57) ABSTRACT

A light detecting device including a plurality of lenses, a first substrate including a plurality of image pixels having a first photodiode configured to output a first signal based on first light that traverses a first portion of the plurality of lenses, a second substrate including a plurality of depth pixels having a second photodiode configured to output a second signal based on second light that traverses a second portion of the plurality of lenses, and a third substrate including first processing circuitry and second processing circuitry. The first processing circuitry is configured to process the first signal into image data and the second processing circuitry is configured to process the second signal into depth data. In a stacking direction the second substrate is disposed on the third substrate, the first substrate is disposed on the second substrate, and the plurality of lenses is disposed on the first substrate.

### CROSS REFERENCE TO RELATED APPLICATIONS

This application claims the benefit of Japanese Priority Patent Application JP2022-192057 filed Nov. 30, 2022, the entire contents of which are incorporated herein by reference.

### TECHNICAL FIELD

The present disclosure relates to a photodetector and an electronic apparatus that are able to acquire two-dimensional image information and depth information.

### BACKGROUND ART

For example, PTL 1 discloses a device to acquire a two-dimensional image and a depth image in which a first sensor including a plurality of two-dimensional image pixels and a plurality of transmission windows, and a second sensor including a plurality of depth pixels are stacked, and a plurality of transmission windows are disposed to be opposed to the plurality of depth pixels.

### CITATION LIST

### Patent Literature

[PTL 1] U.S. Patent Application Publication No. 2021/0305206

### SUMMARY

### Technical Problem

Incidentally, a photodetector that is able to acquire two-dimensional image information and depth information is required to suppress color mixing.

It is desirable to provide a photodetector and an electronic apparatus that make it possible to suppress color mixing.

### Solution to Problem

According to the present disclosure, there is provided a light detecting device including a plurality of lenses, a first substrate including a plurality of image pixels, each image pixel of the plurality of image pixels including a first photodiode configured to output a first signal based on first light that traverses a first portion of the plurality of lenses, a second substrate including a plurality of depth pixels, each depth pixel of the plurality of depth pixels including a second photodiode configured to output a second signal based on second light that traverses a second portion of the plurality of lenses, the second portion including some or all of the first portion, and a third substrate including first processing circuitry and second processing circuitry, the first processing circuitry is configured to process the first signal into image data and the second processing circuitry is configured to process the second signal into depth data, wherein, in a stacking direction, the second substrate is disposed on the third substrate, the first substrate is disposed on the second substrate, and the plurality of lenses is disposed on the first substrate.

There is also provided a light detecting device including a plurality of lenses, a first substrate including a plurality of image pixels, each image pixel of the plurality of image pixels including a first photodiode configured to output data first signal based on first light that traverses a first portion of the plurality of lenses, a second substrate including a plurality of depth pixels, each depth pixel of the plurality of depth pixels including a second photodiode configured to output a second signal based on second light that traverses a second portion of the plurality of lenses, the second portion including some of all of the first portion, and a third substrate including first processing circuitry and second processing circuitry, the first processing circuitry is configured to process the first signal into image data and the second processing circuitry is configured to process the second signal into depth data, light that traverses a single one of the plurality of lenses is received by one of the plurality of image pixels and one of the plurality of depth pixels.

There is also provided an electronic apparatus including a plurality of lenses, a first substrate including a plurality of image pixels, each image pixel of the plurality of image pixels including a first photodiode configured to output data first signal based on first light that traverses a first portion of the plurality of lenses, a second substrate including a plurality of depth pixels, each depth pixel of the plurality of depth pixels including a second photodiode configured to output a second signal based on second light that traverses a second portion of the plurality of lenses, the second portion including some or all of the first portion, and a third substrate including first processing circuitry and second processing circuitry, the first processing circuitry is configured to process the first signal into image data and the second processing circuitry is configured to process the second signal into depth data, wherein, in a stacking direction, the second substrate is disposed on the third substrate, the first substrate is disposed on the second substrate, and the plurality of lenses is disposed on the first substrate.

In some aspects of the present disclosure, light that traverses a single one of the plurality of lenses is received by one of the plurality of image pixels and one of the plurality of depth pixels.

### BRIEF DESCRIPTION OF DRAWINGS

FIG. 1 is a schematic view of an example of a cross-sectional configuration of a photodetector according to an embodiment of the present disclosure.

FIG. 2 is a diagram illustrating an example of a developed perspective configuration of the photodetector illustrated in FIG. 1.

FIG. 3 is an equivalent circuit diagram of a two-dimensional image information acquisition pixel illustrated in FIG. 1.

FIG. 4 is an equivalent circuit diagram of a depth information acquisition pixel illustrated in FIG. 1.

FIG. 5 is a schematic plan view of an example of a layout of color filters illustrated in FIG. 1.

FIG. 6 is a schematic cross-sectional view of an example of a configuration of a light-receiving element provided in the depth information acquisition pixel illustrated in FIG. 1.

FIG. 7 is a perspective view of an example of a positional relationship between the two-dimensional image information acquisition pixel and the depth information acquisition pixel in the photodetector illustrated in FIG. 1.

FIG. 8A is a schematic cross-sectional view of an example of a method of manufacturing the photodetector illustrated in FIG. 1.

FIG. 8B is a schematic cross-sectional view of a step subsequent to FIG. 8A.

FIG. 8C is a schematic cross-sectional view of a step subsequent to FIG. 8B.

FIG. 8D is a schematic cross-sectional view of a step subsequent to FIG. 8C.

FIG. 8E is a schematic cross-sectional view of a step subsequent to FIG. 8D.

FIG. 8F is a schematic cross-sectional view of a step subsequent to FIG. 8E.

FIG. 8G is a schematic cross-sectional view of a step subsequent to FIG. 8F.

FIG. 9A is a schematic cross-sectional view of another example of the method of manufacturing the photodetector illustrated in FIG. 1.

FIG. 9B is a schematic cross-sectional view of a step subsequent to FIG. 9A.

FIG. 9C is a schematic cross-sectional view of a step subsequent to FIG. 9B.

FIG. 10 is a timing diagram illustrating an operation example of the photodetector illustrated in FIG. 1.

FIG. 11 is a schematic plan view of an example of a layout of color filters according to Modification Example 1 of the present disclosure.

FIG. 12 is a schematic plan view of another example of the layout of the color filters according to Modification Example 1 of the present disclosure.

FIG. 13 is a schematic plan view of another example of the layout of the color filters according to Modification Example 1 of the present disclosure.

FIG. 14 is a schematic view of an example of a cross-sectional configuration of a photodetector according to Modification Example 2 of the present disclosure.

FIG. 15 is a schematic view of an example of a cross-sectional configuration of a photodetector according to Modification Example 3 of the present disclosure.

FIG. 16A is a schematic cross-sectional view of another example of the method of manufacturing the photodetector illustrated in FIG. 15.

FIG. 16B is a schematic cross-sectional view of a step subsequent to FIG. 16A.

FIG. 16C is a schematic view of a step subsequent to FIG. 16B.

FIG. 17 is a diagram illustrating an example of a developed perspective configuration of a photodetector according to Modification Example 4 of the present disclosure.

FIG. 18 is a diagram illustrating an example of the developed perspective configuration of the photodetector according to Modification Example 4 of the present disclosure.

FIG. 19 is a schematic view of an example of a cross-sectional configuration of a photodetector according to Modification Example 5 of the present disclosure.

FIG. 20 is a schematic view of another example of the cross-sectional configuration of the photodetector according to Modification Example 5 of the present disclosure.

FIG. 21 is a schematic view of an example of a cross-sectional configuration of a photodetector according to Modification Example 6 of the present disclosure.

FIG. 22A is a schematic cross-sectional view of an example of a method of manufacturing the photodetector illustrated in FIG. 21.

FIG. 22B is a schematic cross-sectional view of a step subsequent to FIG. 22A,

FIG. 22C is a schematic cross-sectional view of a step subsequent to FIG. 22B.

FIG. 22D is a schematic cross-sectional view of a step subsequent to FIG. 22C.

FIG. 22E is a schematic cross-sectional view of a step subsequent to FIG. 22D.

FIG. 22F is a schematic cross-sectional view of a step subsequent to FIG. 22E.

FIG. 23 is a schematic view of an example of a cross-sectional configuration of a photodetector according to Modification Example 7 of the present disclosure.

FIG. 24 is a schematic plan view of an example of a wiring layout in a wiring layer of the photodetector illustrated in FIG. 23.

FIG. 25 is a schematic view of another example of the cross-sectional configuration of the photodetector according to Modification Example 7 of the present disclosure.

FIG. 26 is a schematic view of another example of the cross-sectional configuration of the photodetector according to Modification Example 7 of the present disclosure.

FIG. 27 is a schematic view of an example of a cross-sectional configuration of a photodetector according to Modification Example 8 of the present disclosure.

FIG. 28A is a schematic cross-sectional view of an example of a method of manufacturing the photodetector illustrated in FIG. 27.

FIG. 28B is a schematic cross-sectional view of a step subsequent to FIG. 28A.

FIG. 28C is a schematic cross-sectional view of a step subsequent to FIG. 28B.

FIG. 28D is a schematic cross-sectional view of a step subsequent to FIG. 28C.

FIG. 28E is a schematic cross sectional view of a step subsequent to FIG. 28D.

FIG. 28F is a schematic cross-sectional view of a step subsequent to FIG. 28E.

FIG. 29 is a schematic view of an example of a cross-sectional configuration of a photodetector according to Modification Example 9 of the present disclosure,

FIG. 30 is a schematic view of an example of a cross-sectional configuration of a photodetector according to Modification Example 10 of the present disclosure.

FIG. 31 is a schematic view of an example of a cross-sectional configuration of a photodetector according to Modification Example 11 of the present disclosure.

FIG. 32 is a schematic view of another example of the cross-sectional configuration of the photodetector according to Modification Example 11 of the present disclosure.

FIG. 33 is a schematic view of another example of the cross-sectional configuration of the photodetector according to Modification Example 11 of the present disclosure.

FIG. 34 is a schematic view of another example of the cross-sectional configuration of the photodetector according to Modification Example 11 of the present disclosure.

FIG. 35 is a perspective view of a configuration example of two-dimensional image information acquisition pixels of a photodetector according to Modification Example 12 of the present disclosure, and an example of a positional relationship between the two-dimensional image information acquisition pixels and a depth information acquisition pixel.

FIG. 36 is a block diagram illustrating a configuration example of an electronic apparatus including the photodetector illustrated in FIG. 1.

FIG. 37A is a schematic view of an example of an overall configuration of a photodetection system using the photodetector illustrated in FIG. 1 and other drawings.

FIG. 37B is a diagram illustrating an example of a circuit configuration of the photodetection system illustrated in FIG. 37A.

FIG. 38 is a view depicting an example of a schematic configuration of an endoscopic surgery system.

FIG. 39 is a block diagram depicting an example of a functional configuration of a camera head and a camera control unit (CCU).

FIG. 40 is a block diagram depicting an example of schematic configuration of a vehicle control system.

FIG. 41 is a diagram of assistance in explaining an example of installation positions of an outside-vehicle information detecting section and an imaging section.

### DESCRIPTION OF EMBODIMENTS

Hereinafter, description is given in detail of embodiments of the present disclosure with reference to the drawings. The following description is merely a specific example of the present disclosure, and the present disclosure should not be limited to the following aspects. Moreover, the present disclosure is not limited to arrangements, dimensions, dimensional ratios, and the like of components illustrated in the drawings. It is to be noted that the description is given in the following order.
1. Embodiment (An example of a photodetector in which two-dimensional image acquisition pixels and depth information acquisition pixels are superimposed on each other, and substrates including respective logic circuits are stacked)
2. Modification Example 1 (Another example of a configuration of the photodetector)
3. Modification Example 2 (Another example of the configuration of the photodetector)
4. Modification Example 3 (Another example of the configuration of the photodetector)
5. Modification Example 4 (Another example of the configuration of the photodetector)
6. Modification Example 5 (Another example of the configuration of the photodetector)
7. Modification Example 6 (Another example of the configuration of the photodetector)
8. Modification Example 7 (Another example of the configuration of the photodetector)
9. Modification Example 8 (Another example of the configuration of the photodetector)
10. Modification Example 9 (Another example of the configuration of the photodetector)
11. Modification Example 10 (Another example of the configuration of the photodetector)
12. Modification Example 11 (Another example of the configuration of the photodetector)
13. Modification Example 12 (Another example of the configuration of the photodetector
14. Application Examples
15. Practical Application Examples

### 1. Embodiment

### Schematic Configuration of Photodetector

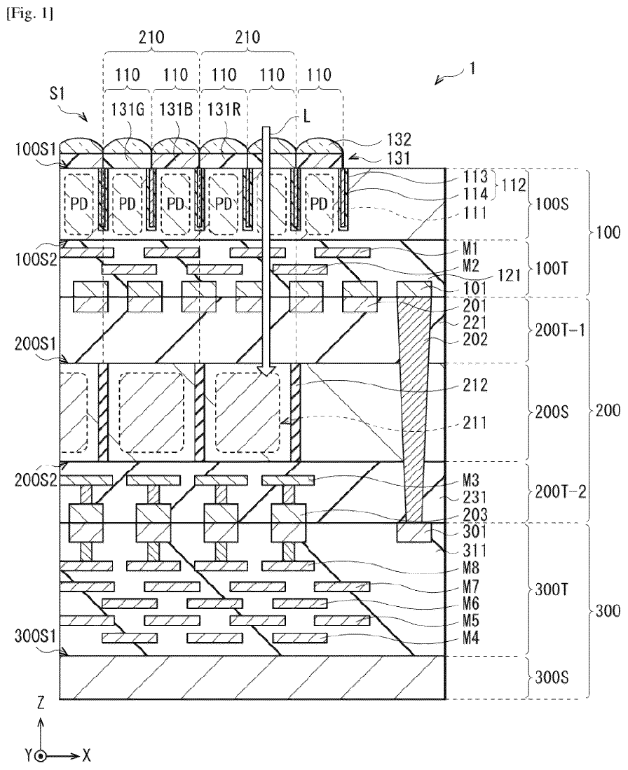

FIG. 1 schematically illustrates an example of a cross-sectional configuration of a photodetector (a photodetector 1) according to an embodiment of the present disclosure. The photodetector 1 includes, for example, three substrates (a first substrate 100, a second substrate 200 and a third substrate 300). The first substrate 100 includes a plurality of pixels 110 that acquires two-dimensional image information. The second substrate 200 includes a plurality of pixels 210 that acquires depth information. The third substrate 300 includes a logic circuit that processes pixel signals outputted from the plurality of pixels 110 and the plurality of pixels 210. The photodetector 1 is a photodetector with a three-dimensional configuration in which the first substrate 100, the second substrate 200, and the third substrate 300 are stacked in this order.

The first substrate 100 includes a light-receiving layer 100S and a wiring layer 100T. The second substrate 200 includes a light receiving layer 200S and wiring layers 200T-1 and 200T2. The third substrate 300 includes a semiconductor layer 300S and a wiring layer 300T. Here, a wiring layer included in each of the substrates of the first substrate 100, the second substrate 200, and the third substrate 300 and an interlayer insulating film around the wiring layer are collectively referred to as a wiring layer (100T, 200T-1, 200T-2, 300T) provided on each of the substrates (the first substrate 100, the second substrate 200, and the third substrate 300) for the sake of convenience. The first substrate 100, the second substrate 200, and the third substrate 300 are stacked in this order, and arranged along a stacking direction (a Z-axis direction) in the order of the light receiving layer 100S, the wiring layer 100T, the wiring layer 200T-1, the light-receiving layer 200S, the wiring layer 200T-2, the wiring layer 300T, and the semiconductor layer 300S. The specific configuration of the first substrate 100, the second substrate 200, and the third substrate 300 are described later. The arrow illustrated in FIG. 1 indicates an incident direction of light L on the photodetector 1. For the sake of convenience, in a cross-sectional diagram, a light incident side in the photodetector 1 may be herein referred to as “down,” “lower side,” and “below,” and an opposite side of the light incident side may be herein referred to as “up,” “upper side,” and “above”, in some cases. Further, for the sake of convenience, with respect to the substrate including a light-receiving layer and a wiring layer, a side of the wiring layer may be herein referred to as a front surface, and a side of the semiconductor layer may be herein referred to as a back surface, in some cases. It is to be noted that the description in the specification is not limited to the above designation. The photodetector 1 is, for example, a back-illuminated imaging device in which light is incident from a side of a back surface of the first substrate 100 including photodiodes PD.

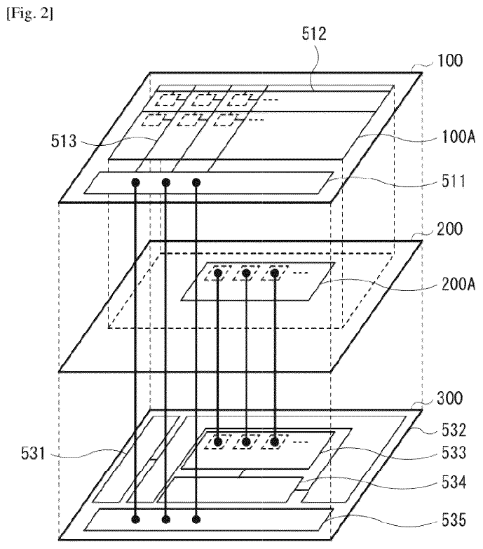

FIG. 2 illustrates an example of a schematic configuration of the photodetector 1.

The first substrate 100 is provided, on the light-receiving layer 100S, with for example, the plurality of pixels 110 that acquires two-dimensional image information by detecting a wavelength of a visible light region. The plurality of pixels 110 are arranged, for example, in an array without gaps in a row direction and a column direction to form a pixel array section 100A. The pixel array section 100A is provided with the plurality of pixels 110 as well as a plurality of row drive signal lines 512 and a plurality of vertical signal lines (column readout lines) 513. The first substrate 100 is further provided with a readout section 511. The row drive signal lines 512 drive, for example, the plurality of pixels 110 arranged side by side in a row direction in the pixel array section 100A. As described later in detail, the plurality of pixels 110 are each provided with a plurality of transistors. In order to drive each of the plurality of transistors, the row drive signal lines 513 are coupled to the respective pixels 110. The pixels 110 are coupled to the respective vertical signal lines 513, and the pixel signals from the pixels 110 are read by the readout section 511 via the respective vertical signal lines 513.

The readout section 511 includes, for example, a loading circuit part that forms a source follower circuit with the plurality of pixels 110. The readout section 511 may include an amplifying circuit part that amplifies the signal read from the pixel 110 via the vertical signal line 513. The readout section 511 may include a noise processing part. In the noise processing section, for example, a system noise level is removed from the signal read from the pixel 110 as a result of photoelectric conversion.

The second substrate 200 is provided with, in the light-receiving layer 200S, for example, the plurality of pixels 210 that acquires depth information by detecting a wavelength in the near-infrared region. For example, the plurality of pixels 210 are arranged in an array in the row direction and the column direction to form a pixel array section 200A. Although not illustrated, a bias voltage application section may further be formed in the second substrate. The bias voltage application section applies a bias voltage to each of the plurality of pixels 210 of the pixel array section 200A.

The third substrate 300 includes the logic circuit that processes the pixel signals outputted from the plurality of pixels 110 that acquires two-dimensional image information and the plurality of pixels 210 that acquires depth information, as described above. Specifically, the third substrate 300 includes, for example, an input/output section 531, a signal processing section 532, a pixel circuit section 533, a histogram generating section 534, and a readout section 535.

The input/output section 531 includes, for example, an input part that inputs, to the photodetector 1, a reference clock signal, a timing control signal, characteristic data, and the like from the outside of the device, and an output part that outputs the image data to the outside of the device. The timing control signal is, for example, a vertical synchronizing signal, a horizontal synchronizing signal, or the like. The characteristic data is to be stored in, for example, the signal processing section 532. The input part includes, for example, an input terminal, an input circuit portion, an input amplitude changing portion, an input data converting circuit portion, and a power supplying portion. The image data is, for example, image data captured by the photodetector 1, image data subjected to signal processing by the signal processing section 532, or another image data. The output part includes, for example, an output data converting circuit portion, an output amplitude changing portion, an output circuit portion, and an output terminal.

The input terminal is an external terminal to which data is to be inputted. The input circuit portion is for taking a signal inputted to the input terminal into the photodetector 1. In the input amplitude changing portion, an amplitude of the signal taken by the input circuit portion is changed into an amplitude that is easy to be used inside the photodetector 1. In the input data converting circuit portion, the arrangement of the data strings of the input data is changed. The input data converting circuit portion is configured by, for example, a serial-parallel conversion circuit. In this serial-parallel conversion circuit, a serial signal received as input data is converted into a parallel signal. It is to be noted that, in the input part, the input amplitude changing portion and the input data converting circuit portion may be omitted. The power supplying portion supplies power set to various voltages required in the photodetector 1 on the basis of power supplied from the outside to the photodetector 1.

When the photodetector 1 is coupled to an external memory device, the input part may be provided with a memory interface circuit that receives data from the external memory device. The external memory device may be, for example, a flash memory, an SRAM, a DRAM, or the like.

The output data converting circuit portion is configured by, for example, a parallel-serial conversion circuit, and in the output data converting circuit portion, a parallel signal used inside the photodetector 1 is converted into a serial signal. The output amplitude changing portion changes an amplitude of the signal used inside the photodetector 1. The signal with the changed amplitude is easily used by an external device coupled to the outside of the photodetector 1. The output circuit portion is a circuit that outputs data from the inside of the photodetector 1 to the outside of the device, and the output circuit portion drives the wiring line outside of the photodetector 1 coupled to the output terminal. In the output terminal, data is outputted from the photodetector 1 to the outside of the device. In the output part, the output data converting circuit portion and the output amplitude changing portion may be omitted.

When the photodetector 1 is coupled to the external memory device, the output part may be provided with a memory interface circuit that outputs data to the external memory device. The external memory device may be, for example, a flash memory, an SRAM, a DRAM, or the like.

The signal processing section 532 is a circuit that performs various types of signal processing on data obtained as a result of photoelectric conversion, in other words, data obtained as a result of an imaging operation in the photodetector 1. The signal processing section 532 includes, for example, an image signal processing circuit part and a data holding part. The signal processing section 532 may include a processor part.

An example of the signal processing to be executed in the signal processing section 532 is a tone curve correction processing. The tone curve correction processing increases a gradation when imaging data subjected to AD conversion is data obtained by capturing an image of a dark subject, and reduces the gradation when the imaging data is data obtained by capturing an image of a bright subject. In this case, it is desirable to cause the data holding part of the signal processing section 532 to store, in advance, characteristic data of the tone curve, such as how the gradation of the imaging data is corrected on the basis of what tone curve.

The pixel circuit section 533 includes, for example, a circuit (a pixel circuit 330) that reads pixel signals outputted from the respective pixels 210. The pixel circuit section 533 includes, for example, a quenching resistor 340 and an inverter 350 coupled to a light-receiving element provided in each of the plurality of pixels 210 (see FIG. 4).

The histogram generating section 534 is configured to generate a histogram of a flight time Ttof of a light pulse detected by the pixel 210 on the basis of the light reception timing of the pixel 210. Specifically, the histogram generating section 534 calculates, on the basis of the light reception timing of the pixel 210, the flight time Ttof of the light pulse detected by the pixel 210. For example, a photodetection system 2000 described later emits light pulses a plurality of times, thereby allowing the histogram generating section 534 to accumulate data of the flight time Ttof for each of the plurality of pixels 210. The histogram generating section 534 generates a histogram of the flight time Ttof for each of the plurality of pixels 210 on the basis of the accumulated data of the flight time Ttof. Then, the histogram generating section 534 specifies the most frequent flight time Ttof on the basis of the histogram of the flight time Ttof of the pixel 210, and determines the flight time Ttof as the flight time Ttof of that pixel 210.

The readout section 535 includes, for example, an analog-to-digital converter (ADC). In the analog-to-digital converter, a signal read from the pixel 110 or an analog signal subjected to the above-described noise processing is converted into a digital signal. The ADC includes, for example, a comparator part and a counter part. In the comparator part, the analog signal to be converted and a reference signal to be compared are compared with each other. In the counter part, the time until a comparison result in the comparator part is reversed is measured.

The third substrate 300 may further include, for example, a row drive section and a timing control section. The row drive section includes a row address control part, in other words, a row decoder part, that determines the position of a row for pixel driving, and a row drive circuit part that generates signals to drive the plurality of pixels 110. The timing control section supplies a signal to control the timing to the row drive section and the readout sections 511 and 535, on the basis of the reference clock signal and the timing control signal inputted to the device.

The first substrate 100, the second substrate 200, and the third substrate 300 are electrically coupled to one another via the wiring layers 100T, 200T-1, 200T-2, and 300T. For example, the first substrate 100 and second substrate 200 are electrically coupled to each other by hybrid bonding. Specifically, the first substrate 100 includes a plurality of contact sections 101 on a joining surface of the wiring layer 100T, and the second substrate 200 includes a plurality of contact sections 201 on a joining surface of the wiring layer 200T-1, with the joining surface of the wiring layer 100T and the joining surface of the wiring layer 200T-1 facing each other. Each of the plurality of contact sections 101 and 201 is an electrode formed by an electrically-conductive material. Examples of the electrically-conductive material include a metallic material such as copper (Cu), aluminum (Al), and gold (Au). For example, the second substrate 200 and the third substrate 300 are electrically coupled to each other by hybrid bonding. Specifically, the second substrate 200 includes a plurality of contact sections 203 on a joining surface of the wiring layer 200T-2, and the third substrate 300 includes a plurality of contact sections 301 on a joining surface of the wiring layer 300T, with the joining surface of the wiring layer 200T-2 and the joining surface of the wiring layer 300T facing each other. Each of the plurality of contact sections 203 and 301 is an electrode formed by an electrically-conductive material. Examples of the electrically-conductive material include a metallic material such as Cu, Al, and Au. For example, the first substrate 100 and the third substrate 300 are electrically coupled to each other by a through-via 202. Specifically, the through-via 202 penetrates the second substrate 200 from the joining surface of the wiring layer 200T-1 with the first substrate 100 to the joining surface of the wiring layer 200T-2 with the third substrate 300. Each of the through-vias 202 is a through-electrode formed by an electrically-conductive material. Examples of the electrically-conductive material include a metallic material such as Cu, Al, and Au. In the second substrate 200 and the third substrate 300, the plurality of contact sections 203 and 301 are directly joined to each other to enable input and/or output of signals. In the first substrate 100 and the third substrate 300, the upper surface of the through-via 202 is directly joined to the contact section 101 and the lower surface of the through-via 202 is directly joined to the contact section 301 to enable input and/or output of signals.

The pixel array section 100A and the pixel array section 200A are formed on the respective substrates to be superimposed in the stacking direction of the first substrate 100, the second substrate 200, and the third substrate 300. In particular, the area of the pixel array section 100A is larger than the area of the pixel array section 200A, and in a plan view, the pixel array section 200A is included in the pixel array section 100A as illustrated in FIG. 2.

The pixel signal outputted from the first substrate 100 is transmitted to the readout section 535 of the third substrate 300 by the vertical signal line 513 for every pixel 110, for example, via the readout section 511 on the chip periphery, and is processed by the signal processing section 532. The pixel signal having been outputted from the second substrate 200 is outputted to and processed by the pixel circuit section 533 of the third substrate 300 for every pixel 210, for example, and then a histogram is generated and outputted by the histogram generating section 534. In the third substrate 300, the pixel circuit 130 of the pixel 110 to acquire the two-dimensional image information and the pixel circuit 330 of the pixel 210 that acquires the depth information are present in a mixed manner, and it is possible to synchronize the operation.

### Circuit Configuration of Two-Dimensional Image Information Acquisition Pixel

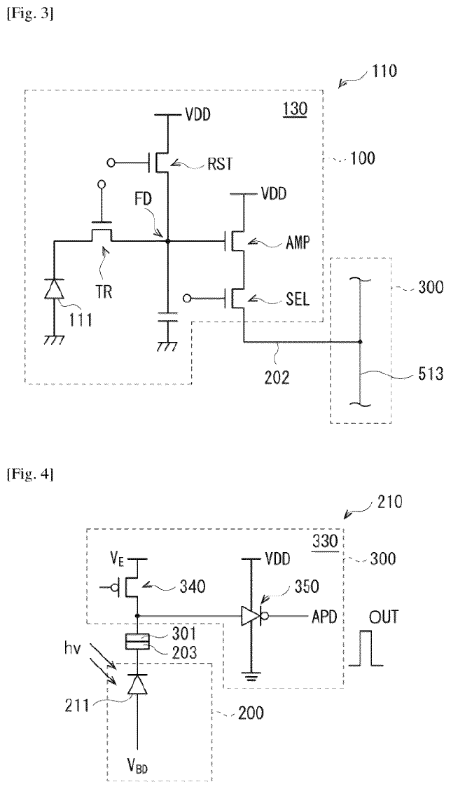

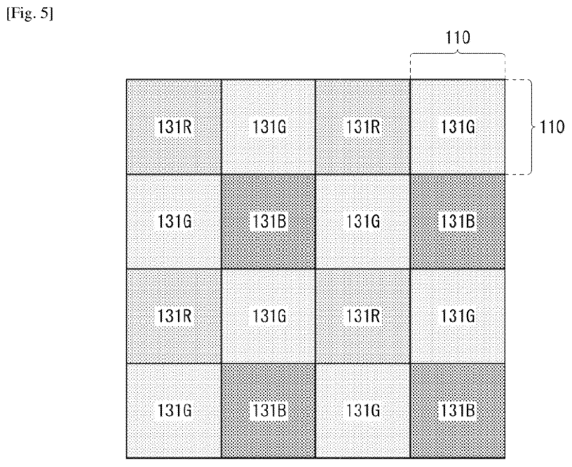

FIG. 3 is an equivalent circuit diagram illustrating an example of a configuration of the pixel 110. The pixel 110 includes a pixel circuit 130 and a vertical signal line 513 coupled to the pixel circuit 130. The pixel circuit 130 includes, for example, three transistors. Specifically, the pixel circuit 130 includes an amplification transistor AMP, a selection transistor SEL, and a reset transistor RST.

The pixel 110 includes, for example, a transfer transistor TR electrically coupled to one light-receiving section 111 (photodiode PD), and a floating diffusion FD electrically coupled to the transfer transistor TR. In the photodiode PD, a cathode is electrically coupled to a source of the transfer transistor TR, and an anode is electrically coupled to a reference potential line (e.g., ground). The photodiode PD photoelectrically converts incident light, and generates charge carriers corresponding to the amount of received light. The transfer transistor TR is, for example, an n-type CMOS (Complementary Metal Oxide Semiconductor) transistor. In the transfer transistor TR, a drain is electrically coupled to the floating diffusion FD, and a gate is electrically coupled to a drive signal line. This drive signal line is a portion of the plurality of row drive signal lines 512 coupled to the pixel 110. The transfer transistor TR transmits the charge carriers generated by the photodiode PD to the floating diffusion FD. The floating diffusion FD is an n-type diffusion-layer region formed in a p-type semiconductor layer. The floating diffusion FD is a charge holding means that temporarily holds the charge carriers transferred from the photodiode PD, and is a charge-voltage converting means that generates a voltage corresponding to the charge amount.

The floating diffusion FD is electrically coupled to a gate of the amplification transistor AMP and a source of the reset transistor RST. A drain of the reset transistor RST is coupled to a power supply line VDD, and a gate of the reset transistor RST is coupled to the drive signal line. This drive signal line is a portion of the plurality of row drive signal lines 512 coupled to the pixels 110. The gate of the amplification transistor AMP is coupled to the floating diffusion PD, a drain of the amplification transistor AMP is coupled to the power supply line VDD, and a source of the amplification transistor AMP is coupled to a drain of the selection transistor SEL. A source of the selection transistor SEL is coupled to the vertical signal line 513, and a gate of the selection transistor SEL is coupled to the drive signal line. The drive signal line is portion of the plurality of row drive signal lines 512 coupled to the pixels 110.

When the transfer transistor TR is brought into an ON state, the transfer transistor TR transfers charge carriers of the photodiode PD to the floating diffusion FD. The gate of the transfer transistor TR includes, for example, a so-called vertical electrode, and is provided to extend from a front surface 100S2 of the light-receiving layer 100S to a depth reaching the photodiode PD. The reset transistor RST resets a potential of the floating diffusion FD to a predetermined potential. When the reset transistor RST is brought into in an ON state, the potential of the floating diffusion FD is reset to a potential of the power supply line VDD. The selection transistor SEL controls an output timing of the pixel signal from the pixel circuit 130. The amplification transistor AMP generates, as a pixel signal, a signal of a voltage corresponding to a level of the charge carriers held in the floating diffusion FD. The amplification transistor AMP is coupled to the vertical signal line 513 via the selection transistor SEL. In the readout section 511, for example, this amplification transistor AMP constitutes a source follower together with a loading circuit part coupled to the vertical signal line 513. When the selection transistor SEL is brought into an ON state, the amplification transistor AMP outputs the voltage of the floating diffusion PD to the readout section 511 via the vertical signal line 513. The reset transistor RST, the amplification transistor AMP, and the selection transistor SEL are each, for example, an N-type CMOS transistor.

The selection transistor SEL may be provided between the power supply line VDD and the amplification transistor AMP. In this case, the drain of the reset transistor RST is electrically coupled to the power supply line VDD and the drain of the selection transistor SEL. The source of the selection transistor SEL is electrically coupled to the drain of the amplification transistor AMP, and the gate of the selection transistor SEL is electrically coupled to the row drive signal line 512. The source of the amplification transistor AMP (an output end of the pixel circuit 130) is electrically coupled to the vertical signal line 513, and the gate of the amplification transistor AMP is electrically coupled to the source of the reset transistor RST.

In the photodetector 1, as illustrated in FIG. 3, the light-receiving section 111 (photodiode PD), the transfer transistor TR electrically coupled to the photodiode PD, the floating diffusion FD electrically coupled to the transfer transistor TR, and the pixel circuit 130 described above are provided in the first substrate 100. The pixel signal outputted to the readout section 511 is transmitted to the readout section 535 of the third substrate 300 via the through-via 202, for example, and various types of processing are performed by the signal processing section 532.

It is to be noted that the pixel circuit 130 may further include an FD conversion gain switching transistor (FDG). The FDG is disposed between the floating diffusion FD and the reset transistor RST. That is, a source of the FDG is electrically coupled to the floating diffusion FD, and a drain of the FDG and the source of the reset transistor RST are electrically coupled to each other.

The FDG is used when changing the gain of charge-voltage conversion in the floating diffusion FD. Generally, a pixel signal is small when shooting in a dark location. When the charge-voltage conversion is performed on the basis of Q=CV, a larger capacitance of the floating diffusion FD (FD capacitance C) when performing the charge-voltage conversion causes V upon converting into a voltage by the amplification transistor AMP to become smaller. Meanwhile, because the pixel signal becomes larger in a bright location, the floating diffusion FD is not able to receive the charge carriers of the photodiode PD, unless the PD capacitance C is large. Further, the FD capacitance C needs to be large to allow V upon converting into a voltage by the amplification transistor AMP not to be too large (in other words, to allow V to be small) when the charge-voltage conversion is performed by the amplification transistor AMP. In view of the above, when the FDG is turned ON, the gate capacitance for the FDG increases, and thus the entire FD capacitance C increases. Meanwhile, when the FDG is turned OFF, the entire FD capacitance C decreases. In this manner, switching the FDG ON and OFF allows the FD capacitance C to be variable, thus making it possible to switch the conversion efficiency. The FDG is, for example, an N-type CMOS transistor.

In addition, FIG. 3 illustrates the example in which one pixel circuit 130 is coupled to one pixel 110, but one pixel circuit 130 may be coupled to a pixel block including the plurality of pixels 110. For example, in a pixel block including four pixels 110 arranged in two rows by two columns, the four pixels 110 share one pixel circuit 130, and the pixel circuit 130 is operated in time division to thereby enable respective pixel signals of the four pixels 110 to be sequentially outputted to the vertical signal line 513. A state in which one pixel circuit 130 is coupled to the plurality of pixels 110, and the pixel signals of these plurality of pixels 110 are outputted by the one pixel circuit 130 in time division, is paraphrased as follows: “the plurality of pixels 110 share the one pixel circuit 130”.

It is to be noted that the number of the pixels 110 sharing one pixel circuit 130 may be four or less. For example, two or eight pixels 110 may share the pixel circuit 130.

### Circuit Configuration of Depth Information Acquisition Pixel

FIG. 4 is an equivalent circuit diagram illustrating an example of a configuration of the pixel 210. As illustrated in FIG. 4, the pixel 210 includes, for example, a light-receiving element (denoted by reference numeral 211 in FIG. 4 for the sake of convenience), a quenching resistor 340 including a p-type MOSFET (Metal Oxide-Semiconductor Field-Effect Transistor), and an inverter 350 including, for example, a complementary type MOSFET.

The light-receiving element converts incident light into an electric signal by photoelectric conversion, and outputs the converted electric signal. The light-receiving element collaterally converts the incident light (photon) into an electric signal by photoelectric conversion, and outputs a pulse corresponding to the incidence of the photon. The light-receiving element is, for example, a SPAD (Single Photon Avalanche Diode) element. The SPAD element has, for example, characteristics in which an avalanche multiplication region X (a depletion layer) is formed by application of a large negative voltage to a cathode, and electrons generated in response to the incidence of one photon cause avalanche multiplication, resulting in flow of a large current. In the light-receiving element, for example, an anode is coupled to the bias voltage application section, and a cathode is coupled to a source terminal of the quenching resistor 340. A device voltage V_{B} is applied from the bias voltage application section to the anode of the light-receiving element.

The quenching resistor 340 is coupled in series with the light-receiving element, and has a source terminal coupled to the cathode of the light-receiving element and a drain terminal coupled to an unillustrated power supply. An excitation voltage V_{B} is applied from the power supply to the drain terminal of the quenching resistor 340. When a voltage of electrons having been subjected to the avalanche multiplication by the light-receiving element reaches a negative voltage V_{BD}, the quenching resistor 340 performs quenching in which the electrons multiplied by the light receiving element are released to return the voltage to an initial voltage.

In the inverter 350, an input terminal is coupled to the cathode of the light-receiving element and the source terminal of the quenching resistor 340, and an output terminal is coupled to an unillustrated arithmetic processing section in a subsequent stage. The inverter 350 outputs a light reception signal on the basis of the charge carriers (signal charge) multiplied by the light-receiving element. More specifically, the inverter 350 shapes the voltage generated by the electrons multiplied by the light-receiving element. Then, the inverter 350 outputs, to the signal processing section 532, a light reception signal (APD OUT) in which a pulse waveform illustrated in FIG. 4 is generated, for example, via the through-via 202 and via the contact sections 203 and 301, with an arrival time of one photon as a starting point. For example, the signal processing section 532 performs arithmetic processing for determining a distance to a subject on the basis of a timing at which the pulse indicating the arrival time of one photon is generated in each light reception signal, and determines the distance for each pixel 210. Then, on the basis of the distances, a distance image is generated in which the distances to the subject detected by the plurality of pixels 210 are arranged in a planar manner.

It is to be noted that an APD (Avalanche Photodiode) element may be used, in addition to the SPAD element, as the light-receiving element.

### Specific Configuration of Photodetector

The first substrate 100 includes the light-receiving layer 100S and the wiring layer 100T in order from a light incident side S1. The light-receiving layer 100S is configured by, for example, a silicon (Si) substrate. The light-receiving layer 100S includes, for example, a p-well in a predetermined region, and an n-type semiconductor region in another region. In the light-receiving layer 100S, for example, a photodiode PD of a p-n junction type is provided for each pixel 110 by the p-well and the n-type semiconductor region.

As the light-receiving layer 100S, there can be used, in addition to the Si substrate, a semiconductor substrate including germanium (Ge), selenium (Se), carbon (C), gallium arsenide (GaAs), gallium phosphide (GaP), nickel antimonide (NiSb), indium antimonide (InSb), indium arsenide (InAs), indium phosphide (InP), gallium nitride (GaN), silicon carbide (SiC), or indium gallium arsenide (InGaAs).

The light-receiving layer 100S is further provided with a separation section 112 between the pixels 110 adjacent to each other. The separation section 112 is to electrically and optically separate the adjacent pixels 110 from each other, and is provided in a grid shape on the pixel array section 100A. The separation section 112 is formed by, for example, a trench having an STI (Shallow Trench Isolation) structure, a DTI (Deep Trench Isolation) structure, or an FFTI (Fall Trench Isolation) structure formed from a side of a back surface 100S1 of the light-receiving layer 100S toward the front surface 100S2. The separation section 112 includes, for example, a light-blocking film 113 and an insulating film 114. The light-blocking film 113 is embedded in the trench, and is formed using a metallic material having a light-blocking property, such as tungsten (W), aluminum (Al), copper (Cu), cobalt (Co), nickel (Ni), or titanium (Ti), or a silicon compound thereof. In addition, the light-blocking film 113 may be formed using polysilicon (Poly-Si). The insulating film 114 is provided between the light-receiving layer 100S and the light-blocking film 113 to coat a side surface and a bottom surface of the trench. The insulating film 114 is formed using, for example, silicon oxide (SiO). The separation section 112 can also be formed by, for example, diffusing p-type impurities.

The above-described pixel circuit 130 is provided for each pixel 110, for example, near the front surface 100S2 of the light-receiving layer 100S. Specifically, the floating diffusion PD, the transfer transistor TR, the selection transistor SEL, the amplification transistor AMP, and the reset transistor RST are provided for each pixel 110, for example, near the front surface 100S2 of the light-receiving layer 100S. The pixel circuit 130 reads the pixel signals transferred from the photodiode PD of each pixel 110 via the transfer transistor TR, or resets the photodiode PD.

The floating diffusion FD is configured by the n-type semiconductor region provided in the p-well. The floating diffusion FD is provided for each pixel 110.

The transfer transistor TR is provided for each pixel 110 on a side of the front surface 100S2 of the light-receiving layer 100S (on a side opposite to a light incident surface side; on a side of the second substrate 200). The transfer transistor TR includes a transfer gate. The transfer gate includes, for example, a horizontal part opposed to the front surface 100S2 of the light-receiving layer 100S and a vertical part provided in the light-receiving layer 100S. The vertical part extends in a thickness direction of the light-receiving layer 100S. One end of the vertical part is in contact with the horizontal part, and another end is provided in the n-type semiconductor region that configures the photodiode PD. The transfer transistor TR configured by such a vertical transistor makes a transfer failure of pixel signals less likely to occur, thus making it possible to improve read-out efficiency of pixel signals.

A VSS contact region or the like is further provided near the front surface 100S2 of the light-receiving layer 100S. The VSS contact region is a region to be electrically coupled to a reference potential line VSS, and is disposed spaced apart from the floating diffusion FD. The VSS contact region is provided for each pixel 110, for example. The VSS contact region is configured by, for example, a p-type semiconductor region. The VSS contact region is coupled to, for example, a grounding potential or a fixed potential. Thus, the reference potential is supplied to the light-receiving layer 100S.

A pinning region is provided, for example, near the back surface 100S1 of the light-receiving layer 100S. The pinning region is also formed, for example, from the vicinity of the back surface 100S1 of the light-receiving layer 100S to the side surface of the separation section 112, specifically, between the separation section 112 and the p-well. The pinning region is configured by, for example, a p-type semiconductor region.

The back surface 100S1 of the light-receiving layer 100S is further provided with, for example, a fixed-charge film and an insulating film having negative fixed charge. Due to the electric field induced by this fixed-charge film, the pinning region is formed at an interface on a side of a light reception surface (back surface 100S1) of the light-receiving layer 100S. This suppresses generation of a dark current caused by an interface state on the side of the light-receiving surface of the light-receiving layer 100S. The fixed-charge film is formed by, for example, an insulating film having negative fixed charge. Examples of a material of the insulating film having the negative fixed charge include hafnium oxide, zirconium oxide, aluminum oxide, titanium oxide, or tantalum oxide.

A light-blocking film is provided between the fixed-charge film and the insulating film. This light-blocking film may be provided continuously with the light-blocking film 113 that configures the separation section 112. The light-blocking film between the fixed-charge film and the insulating film is selectively provided at a position facing the separation section 112 in the light-receiving layer 100S, for example. That is, the light-blocking film is provided in a grid shape on the pixel array section 100A. The insulating film is provided to cover this light-blocking film. The insulating film is formed using, for example, silicon oxide.

An optical member such as a color filter 131 or an on-chip lens 132 is provided on the side of the back surface (light incident side S1) of the first substrate 100.

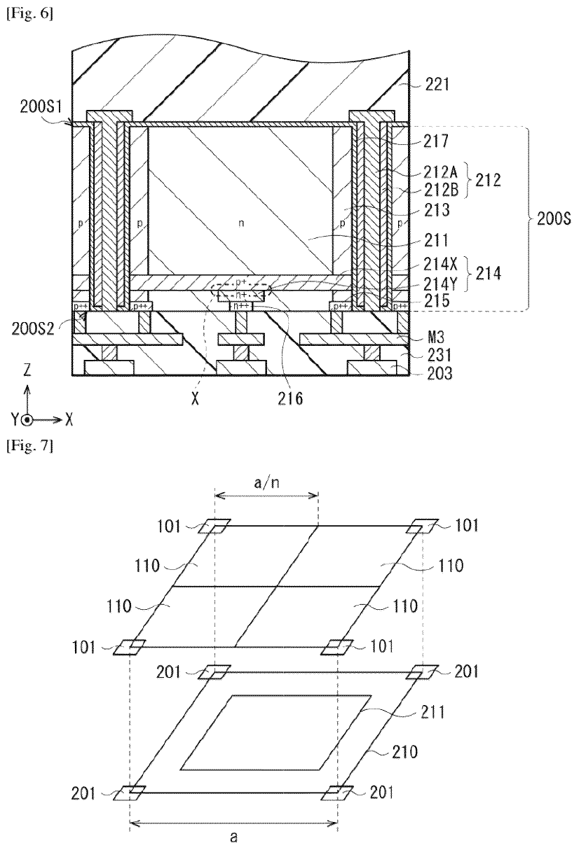

The color filter 131 selectively transmits light of a predetermined wavelength. The color filter 131 includes, for example, a plurality of color filters 131R, 131G, and 131B that selectively transmit red light (R), green light (G), or blue light (B) of visible light, and is provided for each pixel 110. As illustrated in FIG. 7, the color filters 131 are arranged, for example, for four pixels 110 arranged in two rows by two columns. Two color filters 131G that selectively transmit the green light (G) are arranged on a diagonal line, and one color filter 131R that selectively transmits red light (R) and one color filter 131B that selectively transmits blue light (B) are arranged on a diagonal line orthogonal to the above diagonal line. In the pixels 110 provided with the respective color filters 131R, 131G, and 131B, light of a corresponding color is photo-electrically converted in the photodiode PD. That is, in the pixel array section 100A, the respective pixels 110 that detect the red light (R), the green light (G), and the blue light (B) are arranged in a Bayer arrangement. The film thickness of the color filter 131 may differ for each color in view of color reproducibility of the spectral spectrum and sensor sensitivity.

The on-chip lens 132 is provided for, for example, each pixel 110. The on-chip lens 132 is provided for each pixel 110. Examples of a material of the on-chip lens 132 include a resin material having a refractive index of 1.5 or more and 2.0 or less, and an inorganic material such as silicon nitride (SiN), silicon oxynitride (SiON), silicon oxide (SiO), and amorphous silicon. In addition, a high refractive index organic material such as an episulfide-based resin, a thiethane compound, or a resin thereof may be used for the on-chip lens 132. The shape of the on-chip lens 132 is not particularly limited, and various lens shapes such as a hemispherical shape and a semicylindrical shape can be adopted.

For example, a protective film having an antireflection function may be formed on a front surface of the on-chip lens 132. A film thickness of the protective film is, for example, λ/4n with respect to a wavelength λ to be detected and a refractive index n of the protective film.

The wiring layer 100T includes an interlayer insulating layer 121 and a plurality of wiring lines (e.g., wiring layers M1 and M2). The interlayer insulating layer 121 covers the entire front surface 100S2 of the light-receiving layer 100S. The interlayer insulating layer 121 covers the respective gate-electrodes of the transfer transistor TR, the selection transistor SEL, the amplification transistor AMP, and the reset transistor RST. The wiring layers M1 and M2 are provided in this order in the interlayer insulating layer 121. The plurality of wiring lines (wiring layers M1, M2) are separated by the interlayer insulating layer 121. The interlayer insulating layer 121 is configured by, for example, silicon oxide (SiO).

In the wiring layer 100T, for example, the wiring layer M1, the wiring layer M2, and the plurality of contact sections 101 are provided in this order from the side of the light-receiving layer 100S, and are insulated from each other by the interlayer insulating layer 121. The interlayer insulating layer 121 is provided with a plurality of coupling vias that couple a plurality of wiring lines (for example, the wiring layers M1 and M2) and these lower-layer wiring lines. The coupling via is formed by embedding an electrically-conductive material in a coupling hole provided in the interlayer insulating layer 121.

In the wiring layer 100T, a plurality of wiring lines (for example, wiring layers M1 and M2) provided in the interlayer insulating layer 121 couple, for example, the floating diffusion FD to the gate of the amplification transistor AMP and the source of the reset transistor RST. The plurality of wiring lines (e.g., wiring layers M1 and M2) includes, for example, a plurality of row drive signal lines 512 extending in a row direction. The plurality of row drive signal lines 512 are to send drive signals to the transfer transistor TR, the selection transistor SEL, and the reset transistor RST, and are coupled to the respective gates via the coupling vias. The plurality of wiring lines (e.g., wiring layers M1 and M2) includes, for example, the power supply line VDD extending in the column direction, the reference potential line VSS, and the plurality of vertical signal lines 513. The power supply line VDD is coupled to the drain of the amplification transistor AMP and the drain of the reset transistor RST via a coupling via. The reference potential line VSS is coupled to the VSS contact region via a coupling via. The vertical signal line 513 is coupled to the source (Vout) of the selection transistor SEL via a coupling via.

The plurality of contact sections 101 are provided, for example, at intersections of three pixels 110 arranged in two rows by two columns in a plan view. The plurality of contact sections 101 are exposed to the front surface of the first substrate 100 (the surface of the wiring layer 100T facing the second substrate 200). The plurality of contact sections 101 are formed using, for example, Cu, and are used for attaching the first substrate 100 and the second substrate 200 to each other.

The second substrate 200 includes, in order from a side of the first substrate 100, the wiring layer 200T-1, the light-receiving layer 200S, and the wiring layer 200T-2. In the photodetector 1, the second substrate 200 is attached to the first substrate 100 to allow a side of a back surface of the second substrate 200 (a side of the light-receiving layer 200S) to face a side of the front surface of the first substrate 100 (a side of the wiring layer 100T). That is, the second substrate 200 is attached to the first substrate 100 in a face-to-back manner. The light-receiving layer 200S is configured by, for example, a silicon (Si) substrate. In the light-receiving layer 200S, a light-receiving element is provided for each pixel 210.

FIG. 6 schematically illustrates an example of a cross-sectional configuration of the light-receiving element provided for each pixel 210. It is to be noted that, in the drawing, the symbols “p” and “n” represent the p-type semiconductor region and the n-type semiconductor region, respectively. Furthermore, “+” or “−” at the end of “p” indicates an impurity concentration of the p-type semiconductor region. Similarly, “+” or “−” at the end of “n” indicates an impurity concentration of the n-type semiconductor region. Here, the larger number of “+” indicates a higher impurity concentration, and the larger number of “−” indicates a lower impurity concentration.

The light-receiving layer 200S includes a pair of surfaces (a back surface 200S1 and a front surface 200S2) opposed to each other. The light-receiving layer 200S includes a p-well (p) which is common to the plurality of pixels 210. The light-receiving layer 200S is provided with, for example, an n-type semiconductor region (n) in which the impurity concentration is controlled to be in the n-type, which configures the light-receiving section 211 for each pixel 210. The light-receiving layer 200S is further provided with a p-type semiconductor region (p⁺) 214X and an n-type semiconductor region (n⁺) 214Y that configure a multiplication section 214 on a side of the back surface 200S1. As a result, a light-receiving element is formed for each pixel 210. A separation section 212 is provided around the pixel 210 to electrically separate adjacent pixels 210 from each other. A p-type semiconductor region (p) 213 having a higher impurity concentration than that of the p-well is provided between the light-receiving element and the separation section 212.

The light-receiving element has a multiplication region (avalanche multiplication region X) that performs avalanche multiplication on the charge carriers by a high electric field region. As described above, the light-receiving element is the SPAD element that is able to form the avalanche multiplication region X by application of a large negative voltage to a cathode, and able to perform the avalanche multiplication on electrons generated by the incidence of one photon.

The light-receiving element is, for example, the SPAD element, and includes the light-receiving section 211 and the multiplication section 214. The light-receiving section 211 and the multiplication section 214 are embedded and formed in, for example, the light-receiving layer 200S.

The light-receiving section 211 corresponds to a specific example of a “second light-receiving section” according to the present disclosure, and has a photoelectric converting function of absorbing light incident from a side of the front surface 200S2 of the light-receiving layer 200S and generating charge carriers corresponding to the amount of received light. As described above, the light-receiving section 211 includes the n-type semiconductor region (n) whose impurity concentration is controlled to be in an n-type, and the charge carriers (electrons) generated by the light-receiving section 211 are transferred to the multiplication section 214 by a potential gradient.

The multiplication section 214 performs avalanche multiplication on the charge carriers (electrons in this example) generated by the light-receiving section 211. The multiplication section 214 includes, for example, the p-type semiconductor region (p⁺) 214X having an impurity concentration higher than that of the p-well (p), and the n-type semiconductor region (n⁺) 214Y having an impurity concentration higher than that of the n-type semiconductor region (n) configuring the light-receiving section 211. The p-type semiconductor region (p⁺) 214X and the n-type semiconductor region (n⁺) 214Y are provided on the side of the front surface 200S2, and are stacked and formed from the side of the front surface 200S2 in the order of the n-type semiconductor region (n⁺) 214Y and the p-type semiconductor region (p⁺) 214X. The area of the p-type semiconductor region (p⁺) 214X in an X-Y plane direction is larger than the area of the n-type semiconductor region (n⁺) 214Y in the X-Y plane direction, and is provided across the entire surface of the pixel 210 partitioned by the separation section 212, for example. However, this is not limitative, and the p-type semiconductor region (p⁺) 214X may be formed inside the p-type semiconductor region (p) 213, for example.

In the light-receiving element, the avalanche multiplication region X is formed at a junction between the p-type semiconductor region (p⁺) 214X and the n-type semiconductor region (n⁺) 214Y. The avalanche multiplication region X is a high electric field region (depletion layer) formed at a boundary surface between the p-type semiconductor region (p⁺) 214X and the n-type semiconductor region (n⁺) 214Y by a large negative voltage applied to the cathode. In the avalanche multiplication region X, the electrons (e−) generated by one photon incident on the light-receiving element are multiplied.

The front surface 200S2 of the light-receiving layer 200S is further provided with a contact layer 215 including a p-type semiconductor region (p⁺⁺) electrically coupled to the n-type semiconductor region (n) that configures the light-receiving section 211, and a contact layer 216 including an n-type semiconductor region (n⁺⁺) electrically coupled to the n-type semiconductor region (n⁺) 214Y that configures the multiplication section 214. For example, the contact layer 215 is provided along the separation section 212 to surround the light-receiving section 211, and is coupled as an anode of the light-receiving element to the bias voltage application section. The contact layer 216 is coupled as a cathode to a source terminal of the quenching resistor 340.

The separation section 212 electrically separates the adjacent pixels 210 from each other, and is provided in a grid shape on the pixel array section 200A to partition each of the plurality of pixels 210 in a plan view. The separation section 212 extends between the back surface 200S1 and the front surface 200S2 of the light-receiving layer 200S and is formed by a trench having, for example, an FFTI structure that penetrates through the light-receiving layer 200S. The separation section 212 may be provided from the side of the back surface 200S1 of the light-receiving layer 200S, or may be formed from the side of the front surface 200S2.

The separation section 212 includes, for example, a light-blocking film 212A and an insulating film 212B. The light-blocking film 212A is embedded in the trench, and is formed using a metallic material having a light-blocking property such as tungsten (W), aluminum (Al), copper (Cu), cobalt (Co), nickel (Ni) or titanium (Ti), or a silicon compound thereof. In addition, the light-blocking film 212A may be formed using polysilicon (Poly-Si). The insulating film 212B is provided between the light-receiving layer 200S and the light-blocking film 212A to coat the side surface and the bottom surface of the trench. The insulating film 212B is formed using, for example, silicon oxide (SiO).

The side surface and the bottom surface of the separation section 212 and the back surface 200S1 of the light-receiving layer 200S may be provided with, for example, a layer having fixed charge (a fixed-charge film 217). The fixed-charge film 217 may be a film having a positive fixed charge or a film having a negative fixed charge.

As a material to configure the fixed-charge film 217, a semiconductor material having a wider bandgap than that of the light-receiving layer 200S or an electrically-conductive material is preferably used for formation. This makes it possible to suppress generation of a dark current at the interface of the light receiving layer 200S. Examples of the material to configure the fixed-charge film 217 include hafnium oxide (HfOₓ), aluminum oxide (AlOₓ), zirconium oxide (ZrOₓ)), tantalum oxide (TaOₓ), titanium oxide (TiOₓ), lanthanum oxide (LaOₓ), praseodymium oxide (PrOₓ), cerium oxide (CeOₓ), neodymium oxide (NdOₓ), promethium oxide (PmOₓ), samarium oxide (SmOₓ), europium oxide (EnOₓ), gadolinium oxide (GdOₓ), terbium oxide (TbOₓ), dysprosium oxide (DyOₓ), holmium oxide (HoOₓ), thulium oxide (TmOₓ), ytterbium oxide (YbOₓ), lutetium oxide (LuOₓ), yttrium oxide (YOₓ), hafnium nitride (HfNₓ), aluminum nitride (AlNₓ), hafnium oxynitride (HfOₓN_{y}), and aluminum oxynitride (AlOₓN_{y}).

To configure the light-receiving layer 200S, there can be used, in addition to the Si substrate, a semiconductor substrate including germanium (Ge), selenium (Se), carbon (C), gallium arsenide (GaAs), gallium phosphide (GaP), nickel antimonide (NiSb), indium antimonide (InSb), indium arsenide (InAs), indium phosphide (InP), gallium nitride (GaN), silicon carbide (SiC), or indium gallium arsenide (InGaAs).

The wiring layer 200T-1 is provided on the side of the back surface 200S1 of the light-receiving layer 200S. The wiring layer 200T-1 includes an interlayer insulating layer 221 and the plurality of contact sections 201. The interlayer insulating layer 221 covers the entire back surface 200S1 of the light-receiving layer 200S. The interlayer insulating layer 221 is configured by, for example, silicon oxide (SiO). The plurality of contact sections 201 are provided at four corners of the pixel 210 having, for example, a rectangular shape in a plan view. The plurality of contact sections 201 are exposed to the front surface of the second substrate 200 (the surface of the wiring layer 200T-1 facing the first substrate 100). The plurality of contact sections 201 are formed using, for example, Cu, and are respectively in contact with the plurality of contact sections 101 of the first substrate 100. That is, the first substrate 100 and the second substrate 200 are bonded to each other by so-called Cu—Cu bonding, and are electrically coupled to each other.

The wiring layer 200T-2 includes an interlayer insulating layer 231 and one or a plurality of wiring lines (e.g., a wiring layer M3). The interlayer insulating layer 231 covers the entire front surface 200S2 of the light-receiving layer 200S. The wiring layer M3 is provided in the interlayer insulating layer 231. The interlayer insulating layer 231 is configured by, for example, silicon oxide (SiO).

In the wiring layer 200T-2, for example, the wiring layer M3 and the plurality of contact sections 203 are provided in this order from the side of the light-receiving layer 200S, and are insulated from each other by the interlayer insulating layer 231. The interlayer insulating layer 231 is provided with one or a plurality of wiring lines (e.g., the wiring layer M3), and, for example, a plurality of coupling vias to couple the contact layers 215 and 216 to each other. The coupling via is formed by embedding an electrically-conductive material in a coupling hole provided in the interlayer insulating layer 231.

In the wiring layer 200T-2, the one or the plurality of wiring lines (e.g., the wiring layer M3) provided in the interlayer insulating layer 231 are used to supply a voltage to be applied to the light-receiving layer 200S or a light-receiving element, for example, and to cause the charge carriers generated in the light-receiving element to be read as signal charge to the pixel circuit 330 of the pixel circuit section 533. Some of the wiring lines of the wiring layer M3 are electrically coupled to the contact layer 215 via the coupling vias. In addition, some of the wiring lines of the wiring layer M3 are electrically coupled to the contact layer 216 via the coupling vias.

The plurality of contact sections 203 is exposed to the front surface of the second substrate 200 (the surface of the wiring layer 200T-2 facing the third substrate 300). The plurality of contact sections 203 is formed using, for example, Cu, and are used for attaching the second substrate 200 and the third substrate 300 to each other.

The second substrate 200 further includes the through-via 202 penetrating the second substrate 200. Specifically, the through-via 202 extends from a surface of the wiring layer 200T-1 facing the first substrate 100 toward a surface of the wiring layer 200T-2 facing the third substrate 300. On the surface of the wiring layer 200T-1 facing the first substrate 100, the through-via 202 is in contact with the contact section 101 of the first substrate 100. The surface of the wiring layer 200T-2 facing the third substrate 300 is in contact with the contact section 301 of the third substrate 300. That is, the first substrate 100 and the third substrate 300 are electrically coupled to each other via the through-via 202. The through-via 202 is formed using a metallic material such as copper (Cu), aluminum (Al), or gold (Au), for example. Alternatively, the through-via 202 may be formed using polysilicon (Poly-Si).

The third substrate 300 includes, for example, the wiring layer 300T and the semiconductor layer 300S in this order from a side of the second substrate 200. For example, the front surface 300S1 of the semiconductor layer 300S is provided on the side of the second substrate 200. The semiconductor layer 300S is configured by a silicon (Si) substrate, for example. A logic circuit is provided, for example, at a portion on a side of the front surface of this semiconductor layer 300S. Specifically, for example, the input/output section 531, the signal processing section 532, the pixel circuit section 533, the histogram generating section 534, and the readout section 535 are provided at the portion on the side of the front surface of the semiconductor layer 300S.

The wiring layer 300T provided between the semiconductor layer 300S and the second substrate 200 includes, for example, an interlayer insulating layer 311, a plurality of wiring lines (wiring layers M4, M5, M6, M7, and M8) separated by the interlayer insulating film, and the plurality of contact sections 301. The plurality of contact sections 301 is exposed to a front surface of the wiring layer 300T (the surface on the side of the second substrate 200). The plurality of contact sections 301 is electrically coupled to a circuit formed in the semiconductor layer 300S (for example, at least one of the input/output section 531, the signal processing section 532, the pixel circuit section 533, the histogram generating section 534, or the readout section 535). The plurality of contact sections 301 is formed using, for example, Cu, and are in contact with the plurality of contact sections 203 of the second substrate 200, respectively. That is, the second substrate 200 and the third substrate 300 are bonded to each other by so-called Cu—Cu bonding, and electrically coupled to each other.

In the photodetector 1, the pixel 110 to acquire two-dimensional image information provided in the first substrate 100 and the pixel 210 to acquire depth information or depth data provided in the second substrate 200 are superimposed in the stacking direction (Z-axis direction) as illustrated in FIG. 1. For example, a pixel size of the pixel 110 is smaller than a pixel size of the pixel 210, and the plurality of pixels 110 and one pixel 210 are superimposed in the Z-axis direction. In other words, in the photodetector 1, the plurality of pixels 110 are superimposed on one pixel 210 in the Z-axis direction, and signal light (light L) detected by the pixel 210 is incident on the light-receiving section 211 of the pixel 210 via the light-receiving section 111 of the pixel 110.

In addition, it is preferable that the pitch of the pixel 210 and the pitch of the plurality of pixels 110 superimposed on the one pixel 210 substantially coincide with each other. In other words, when the plurality of pixels 110 superimposed on the one pixel 210 are set as a unit pixel block, it is preferable that the pitch of the pixel 210 and the pitch of the unit pixel blocks substantially coincide with each other. Specifically, for example, as illustrated in FIG. 7, when a unit pixel block superimposed on the one pixel 210 includes n² pieces of the pixels 110 arranged in n rows×n columns, it is preferable that the pitch of the pixel 110 be a/n of the pitch a of the pixel 210. This makes it possible to dispose the contact sections 101 and 201 that attach the first substrate 100 and the second substrate 200 to each other, for example, between the adjacent unit pixel blocks and between the adjacent pixels 210, as illustrated in FIG. 7, not to block light L to be incident on a light-receiving section 322.

### Method of Manufacturing Photodetector

The photodetector 1 can be manufactured as follows, for example.

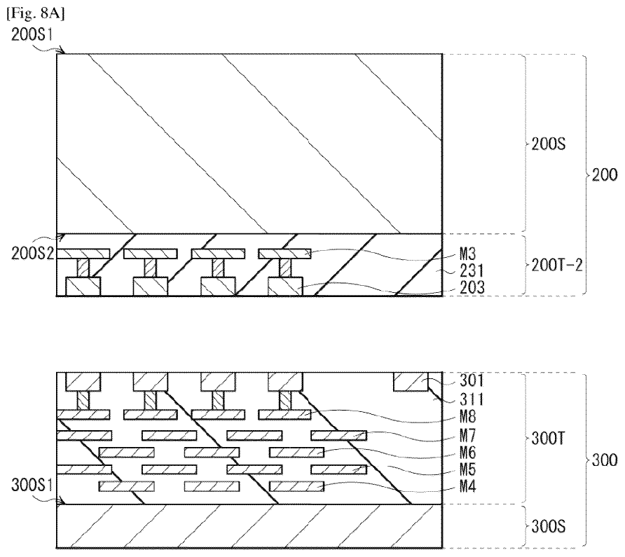

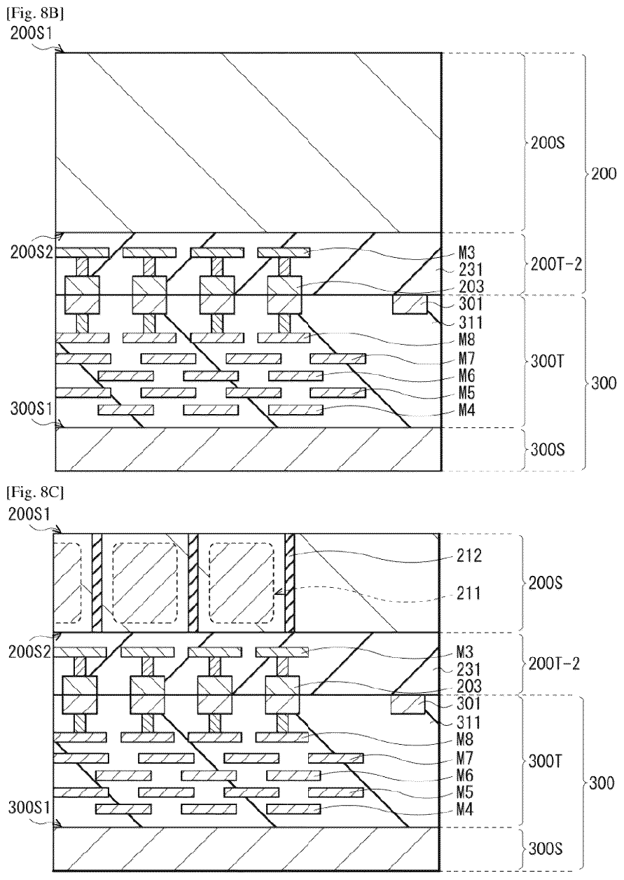

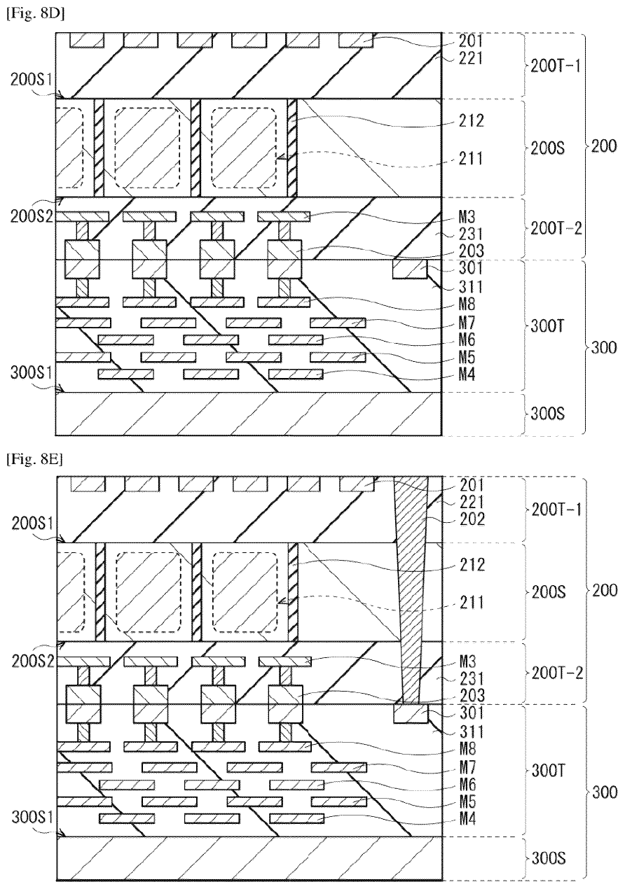

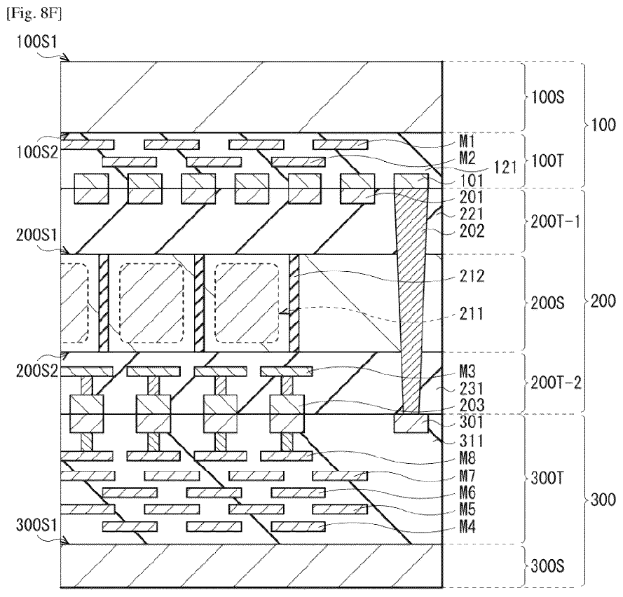

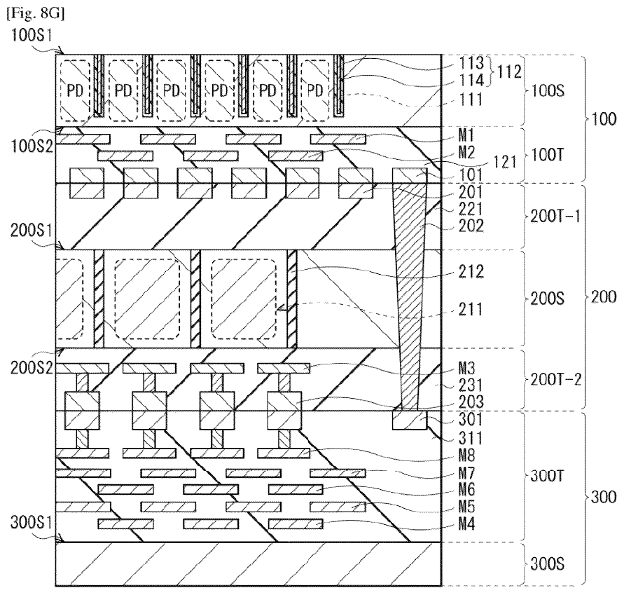

First, the wiring layer 200T-2 is formed on the front surface 200S2 of the light-receiving layer 200S, and the wiring layer 300T is formed on the front surface 300S1 of the semiconductor layer 300S, and then, as illustrated in FIG. 8A, the wiring layer 200T-2 of the second substrate 200 and the wiring layer 300T of the third substrate 300 are disposed to face each other.

Next, as illustrated in FIG. 8B, the plurality of contact sections 203 and the plurality of contact sections 301 respectively exposed on the front surface of the wiring layer 200T-2 and the front surface of the wiring layer 300T are attached to each other, to allow the second substrate 200 and the third substrate 300 to be hybrid-bonded.

Subsequently, as illustrated in FIG. 8C, after thinning the light-receiving layer 200S using, for example, a CMP (Chemical Mechanical Polishing) method, a plurality of light-receiving elements and the separation sections 212 are formed in the light-receiving layer 200S.

Next, as illustrated in FIG. 8D, the wiring layer 200T-1 including the plurality of contact sections 201 on the front surface is formed on the back surface 200S1 of the light-receiving layer 200S by a REOL step.

Subsequently, as illustrated in FIG. 8E, the through-via 202 reaching the contact section 301 from the front surface of the wiring layer 200T-1 is formed by using, for example, a photolithography technique, etching, sputtering, or the like.

Next, as illustrated in FIG. 8F, the first substrate 100 that is separately formed and the second substrate 200 are hybrid-bonded by attaching together the plurality of contact sections 101 exposed to the front surface of the wiring layer 100T and the plurality of contact sections 201 exposed to the front surface of the wiring layer 200T-1.

Subsequently, as illustrated in FIG. 8G, after thinning the light-receiving layer 100S using, for example, a CMP method, a plurality of photodiodes PD and the separation sections 112 are formed in the light-receiving layer 100S. Thereafter, the color filters 131 and the on-chip lenses 132 are sequentially formed on the back surface 100S1 of the light-receiving layer 100S. Thus, the photodetector 1 illustrated in FIG. 1 is completed.

It is to be noted that the through-via 202 may be formed as follows, for example.

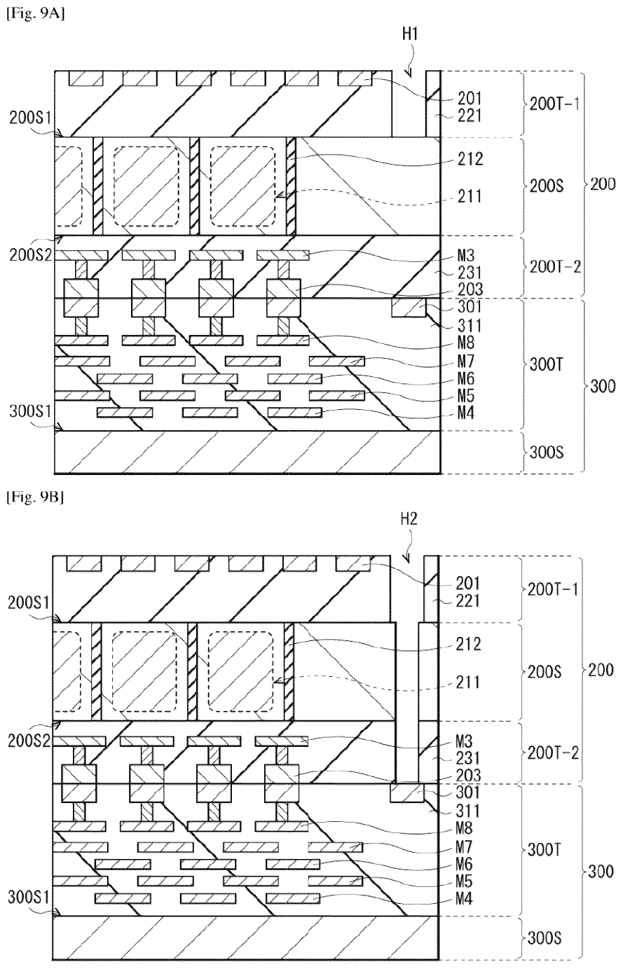

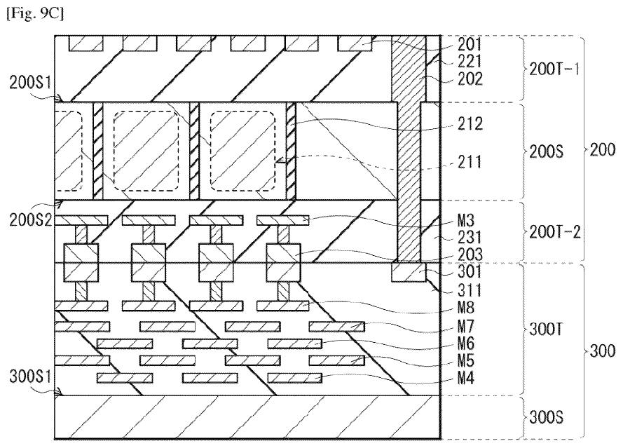

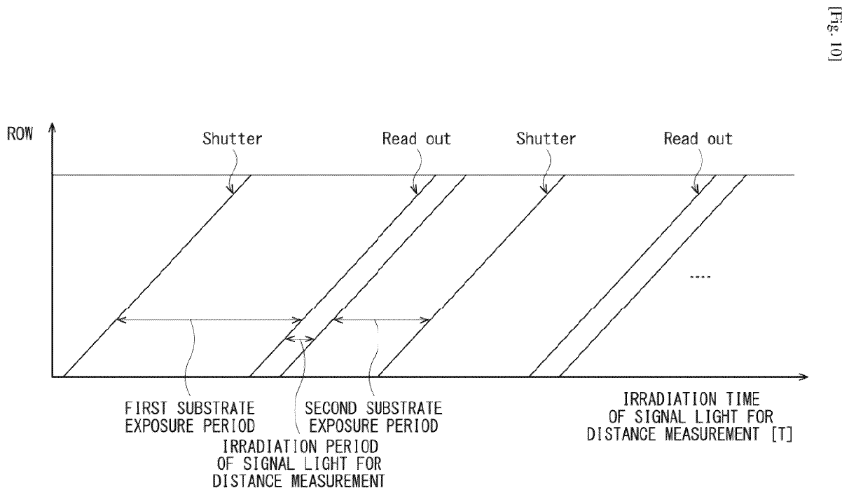

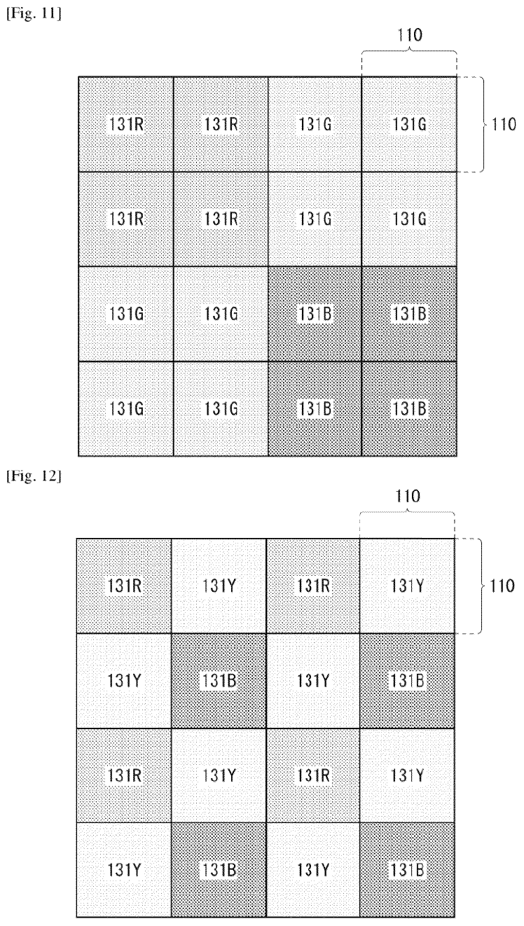

First, the wiring layer 200T-1 including the plurality of contact sections 201 on the front surface is formed on the back surface 200S1 of the light-receiving layer 200S, and then, as illustrated in FIG. 9A, an opening H1 penetrating the interlayer insulating layer 221 is formed by, for example, a photolithography technique and etching.

Next, as illustrated in FIG. 9B, an opening H2 penetrating the light-receiving layer 200S and the interlayer insulating layer 231 is formed in the opening H1 by, for example, a photolithography technique and etching.

Thereafter, as illustrated in FIG. 9C, the through-via 202 is formed by filling the openings H1 and H2 with an electrically-conductive material by, for example, sputtering, or the like. As described above, by forming the opening reaching the contact section 301 from the front surface of the wiring layer 200T-1 in two or more stages, the process controllability of the respective layers with different etching rates is improved.

### Operation of Photodetector

FIG. 10 is a timing diagram illustrating an operation example of the photodetector 1. In the photodetector 1, the first substrate 100 in which the plurality of pixels 110 to acquire two-dimensional image information are arranged in an array, the second substrate 200 in which the plurality of pixels 210 to acquire depth information are arranged in an array to be superimposed on the plurality of pixels 110, and the third substrate 300 including a logic circuit to process pixel signals outputted from the plurality of pixels 110 and the plurality of pixels 210 are stacked in this order. In the photodetector 1, as illustrated in FIG. 10, the second substrate 200 is able to be irradiated with light L (signal light for distance measurement) to acquire depth information at the timing of reading (Read out) of the first substrate, thus making it possible to separate an exposure period of the first substrate 100 and an exposure period of the second substrate 200 from each other. This makes it possible to suppress color mixing.

### Workings and Effects

In the photodetector 1 of the present embodiment, the first substrate 100 in which the plurality of pixels 110 to acquire two-dimensional image information are arranged in an array, the second substrate 200 including a second light-receiving layer in which the plurality of pixels 210 to acquire depth information are arranged in an array to be superimposed on the plurality of pixels 110, and the third substrate 300 including a logic circuit to process pixel signals that are outputted from the plurality of pixels 110 and the plurality of pixels 210 are stacked in this order. This is described below.

In recent years, a sensor that is able to acquire both a two-dimensional image and a depth image has been developed. In such a sensor, for example, a structure may be considered in which a sensor to acquire a two-dimensional image and a sensor to acquire a depth image are arranged side by side or stacked.

However, in a case where a sensor to acquire the two-dimensional image and a sensor to acquire the depth image are arranged side by side, a mismatch occurs between a pixel to acquire the two-dimensional image information and a corresponding distance measuring point. Further, the increase in the area of a module increases the cost. For these reasons, it is desirable to stack the sensor to acquire the two-dimensional image and the sensor to acquire the depth image.

As a structure in which the sensor to acquire a two-dimensional image and the sensor to acquire a depth image are stacked, a stacked structure in which the sensor to acquire two-dimensional image information and the sensor to acquire depth information are stacked in order from a light incident side, and a stacked structure in which the sensor to acquire depth information and the sensor to acquire two-dimensional image information are stacked in order from the light incident side may be considered. However, in the sensor to acquire depth information, each pixel is required to be coupled to a time-to-digital converter (TDC) on a logic side. Therefore, in a case where the sensor to acquire two-dimensional image information is placed below the sensor to acquire depth information, the wiring lines of the sensor to acquire depth information are not able to be routed. For these reasons, in the structure in which the sensor to acquire a two-dimensional image and the sensor to acquire a depth image are stacked, the structure in which the sensor to acquire two-dimensional image information and the sensor to acquire depth information are stacked in order from the light incident side is desirable.

As such a sensor, as described above, there has been reported a device to acquire a two-dimensional image and a depth image in which a transmission window is provided between two-dimensional image pixels adjacent to each other, and a depth pixel is arranged at a position facing the transmission window. In such an acquisition device, however, optical axes of the sensor to acquire the two-dimensional image and the sensor to acquire the depth image are deviated from each other, or the logic circuit is a separate chip and driving is not adjusted in time, and thus it is not possible to obtain a device in which both the time component and the spatial component match.

In contrast, in the present embodiment, the first substrate 100 including the light-receiving layer 100S in which the plurality of pixels 110 to acquire two-dimensional image information are arranged in an array and the second substrate 200 including the light-receiving layer 200S in which the plurality of pixels 210 to acquire depth information are arranged in an array are stacked, and the pixels 110 and the pixels 210 are disposed to be superimposed on each other. Further, the third substrate 300 including a logic circuit that processes the pixel signals outputted from the plurality of pixels 110 and the plurality of pixels 210 is stacked on the side of the second substrate 200. This makes it possible to align the optical axes and acquire the two-dimensional image information and the depth information. In addition, it is possible to synchronize driving of the pixels 110 and the pixels 210.

As described above, in the photodetector 1 of the present embodiment, it is possible to match the time component and the spatial component of the pixels 110 to acquire the two-dimensional image information and the pixels 210 to acquire the depth information. Therefore, it is possible to suppress color mixing.

Modification Examples 1 to 12, Application Examples, and Practical Application Examples of the above-described embodiment are described below. Hereinafter, components similar to those of the above-described embodiment are denoted by the same reference numerals, and descriptions thereof are omitted as appropriate.

### 2. Modification Example 1

FIG. 11 schematically illustrates an example of a layout of the color filters 131 according to Modification Example 1 of the present disclosure,

In the above embodiment, the example is illustrated in which the plurality of color filters 131R, 131G, and 131B that selectively transmit red light (R), green light (G), or blue light (B) are arranged, for example, for the four pixels 110 arranged in two rows by two columns. In the example, two color filters 131G are arranged on a diagonal line, and one color filter 131R and one color filter 131B are arranged on a diagonal line orthogonal to the above diagonal line. In contrast, the color filters 131 may be arranged to allow the color filters 131R, 131G, or 131B of the same color to correspond to a pixel block including the plurality of pixels 110, for example.

Specifically, as illustrated in FIG. 11, for example, a pixel block including the four pixels 110 arranged in two rows by two columns may be used as a repeating unit; in the pixel array section 100A in which the pixel blocks are arranged in an array in the row direction and the column direction, the color filters 131R, 131G, and 131B may be arranged in a Bayer arrangement in units of pixel blocks.

In addition, the color filters 131 may include, instead of the color filter 131G that selectively transmits green light (G), a color filter 131Y that selectively transmits yellow (Y) that is a complementary color. In the colors filter 131 including the color filters 131R, 131B, and 131Y, as illustrated in FIG. 12, for example, two color filters 131Y are arranged on a diagonal line, and one color filter 131R and one color filter 131B are arranged on a diagonal line orthogonal to the above diagonal line in a Bayer arrangement, for example, for the four pixels 110 arranged in two rows by two columns.

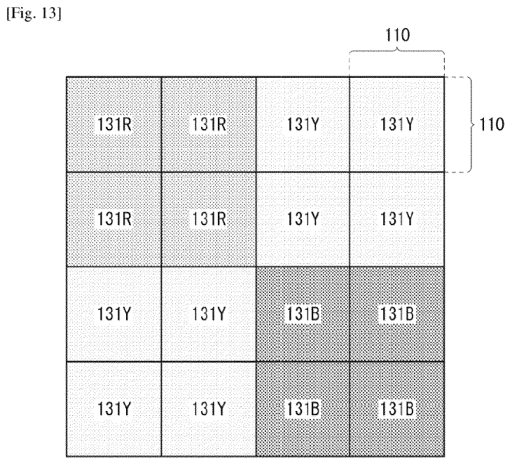

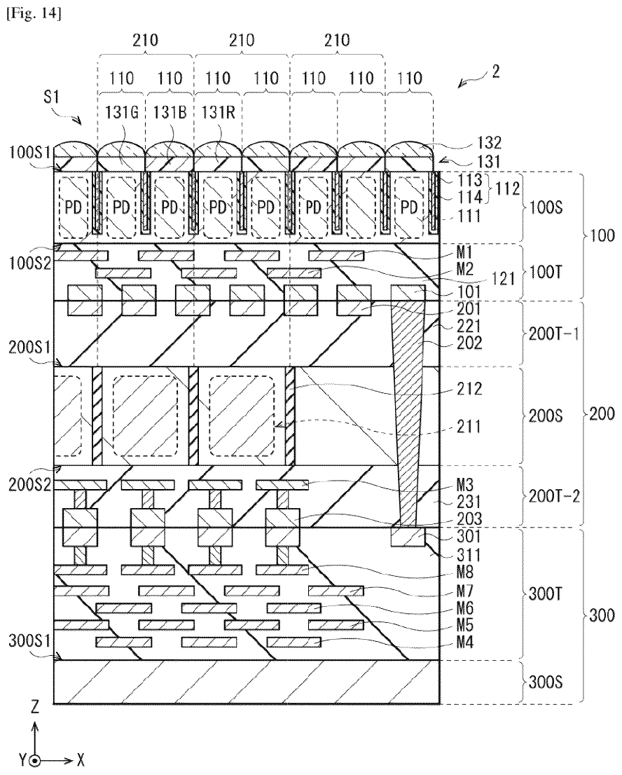

In the same manner as the layout illustrated in FIG. 11, in the color filters 131 including the color filters 131R, 131B, and 131Y, as illustrated in FIG. 13, for example, a pixel block including the four pixels 110 arranged in two rows by two columns may be used as a repeating unit; in the pixel array section 100A in which the pixel blocks are arranged in an array in the row direction and the column direction, the color filters 131R, 131B, and 131Y may be arranged in a Bayer arrangement in units of pixel blocks.

In addition, FIGS. 11 and 13 illustrate examples in which the pixel blocks in which the color filters 131R, 131G (or 131Y), and 131B are provided include the same number of the pixels 110; however, this is not limitative. For example, the pixel unit in which the color filters 131R or 131B are arranged may include eight pixels 110, and the pixel unit in which the color filters 131G (or 131Y) are arranged may include ten pixels 110.

Further, the color filters 131 may include filters that selectively transmit cyan, magenta, and yellow, respectively.

### 3. Modification Example 2

FIG. 14 schematically illustrates an example of a cross-sectional configuration of a photodetector (a photodetector 2) according to Modification Example 2 of the present disclosure.

In the above embodiment, an example is illustrated in which the through-via 202 that electrically couples the first substrate 100 and the third substrate 300 to each other is provided outside the pixel array section 100A in which the plurality of pixels 110 are arranged in an array.

In contrast, in the photodetector 2 of the present modification example, the through-via 202 is provided inside the pixel array section 100A. In other words, as illustrated in FIG. 14, the through-via 202 is provided below the plurality of pixels 110 arranged in an array.

As described above, in the present modification example, the through-via 202 is provided below the plurality of pixels 110 arranged in an array, thus making it possible to reduce the region in which the through-via 202 is disposed. That is, it is possible to reduce a chip area of the first substrate 100. Therefore, it is possible to achieve a reduction in the size of the photodetector, in addition to the advantages of the above-described embodiment.

### 4. Modification Example 3

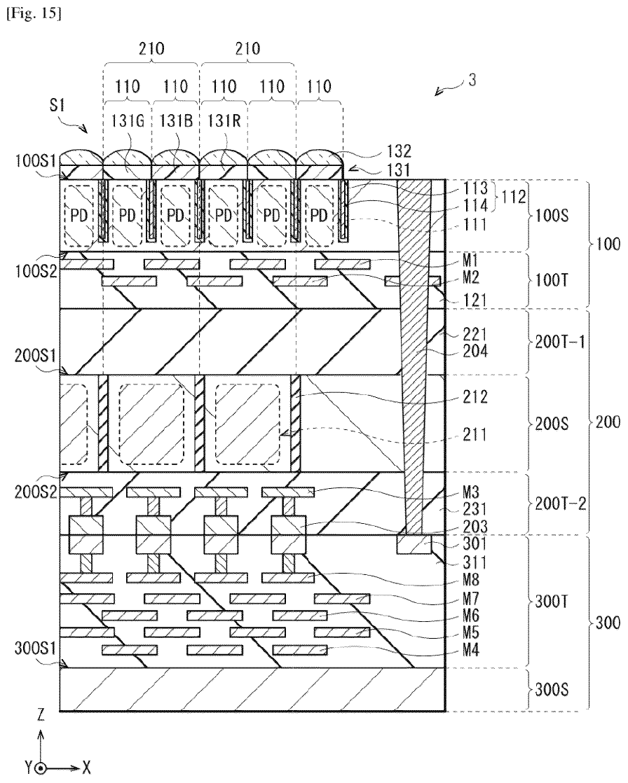

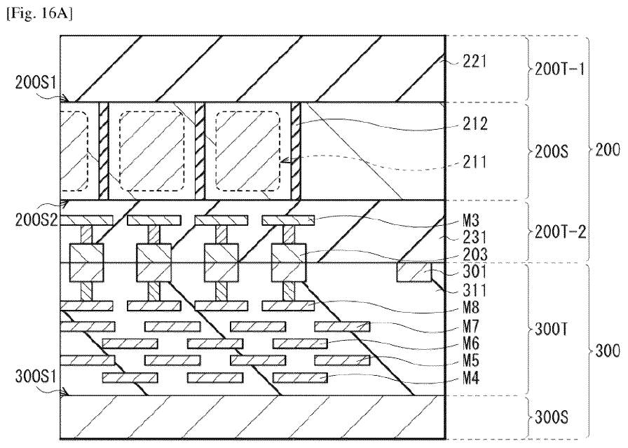

FIG. 15 schematically illustrates an example of a cross-sectional configuration of a photodetector (a photodetector 3) according to Modification Example 3 of the present disclosure.

In the above embodiment, the example is illustrated in which the first substrate 100 and the second substrate 200 are electrically coupled using hybrid bonding by which the plurality of contact sections 101 and the plurality of contact sections 201 provided respectively on the front surface of the wiring layer 100T and the front surface of the wiring layer 200T-1 facing each other are attached together.

In contrast, in the photodetector 3 of the present modification example, for example, providing a through-via 204 that penetrates the light-receiving layer 100S, the wiring layers 100T and 200T-1, the light-receiving layer 200S, and the wiring layer 200T-2, from the back surface 100S1 of the light-receiving layer 100S toward the third substrate 300 allows the first substrate 100 and the second substrate to be electrically coupled to each other and the first substrate and the third substrate 300 to be electrically coupled to each other.

The photodetector 3 can be manufactured as follows, for example.

First, in the same manner as in the above embodiment, the plurality of contact sections 203 exposed to the front surface of the wiring layer 200T-2 and the plurality of contact sections 301 exposed to the front surface of the wiring layer 300T are attached to each other, and the second substrate 200 and the third substrate 300 are hybrid-bonded. Thereafter, the light-receiving layer 200S is thinned to form a plurality of light-receiving elements and the separation sections 212.

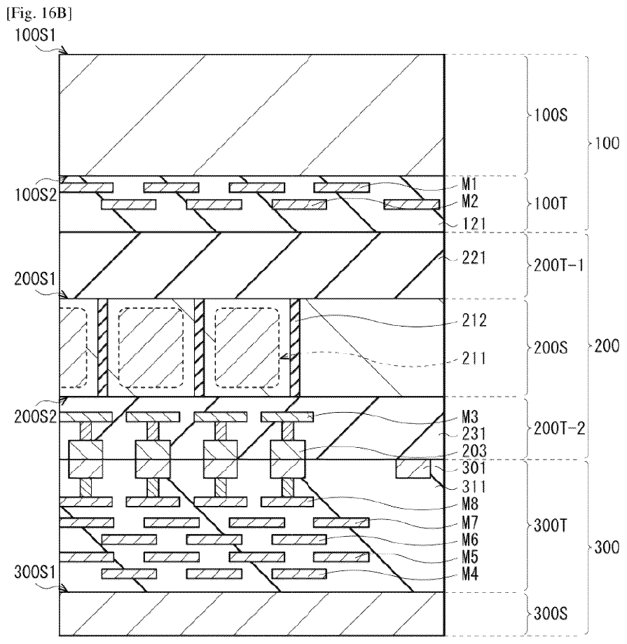

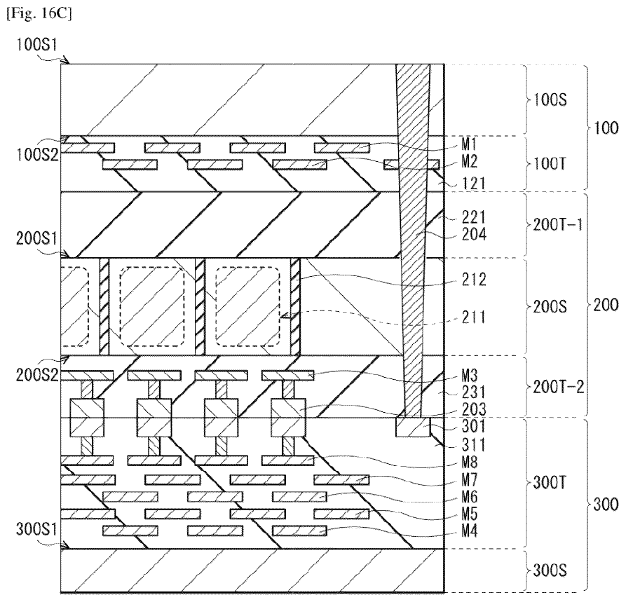

Next, as illustrated in FIG. 16A, the wiring layer 200T-1 is formed on the back surface 200S1 of the light-receiving layer 200S by REOL step, in the same manner as the above embodiment.

Subsequently, as illustrated in FIG. 16B, the first substrate 100 that is separately formed and the second substrate 200 are attached to each other to allow the respective wiring layers 100T and 200T-1 to face each other.

Next, the light-receiving layer 100S is thinned using, for example, a CMP method, and then, as illustrated in FIG. 16C, the through-via 204 reaching the contact section 301 from the back surface 200S1 of the light-receiving layer 200S is formed by, for example, a photolithography technique, etching, sputtering, or the like. Thereafter, a plurality of photodiodes PD and the separation sections 112 are formed in the light-receiving layer 100S, and then the color filters 131 and the on-chip lenses 132 are sequentially formed on the back surface 100S1 of the light-receiving layer 100S. Thus, the photodetector 3 illustrated in FIG. 15 is completed.

As described above, in the present modification example, the through-via 204 reaching the third substrate 300 from the back surface 100S1 of the light-receiving layer 100S is provided; the first substrate 100 and the second substrate 200 are electrically coupled to each other, and the first substrate 100 and the third substrate 300 are electrically coupled to each other. This makes it possible to simplify the manufacturing step as compared with the photodetector 1 of the above embodiment in which the hybrid bonding is performed twice.

### 5. Modification Example 4

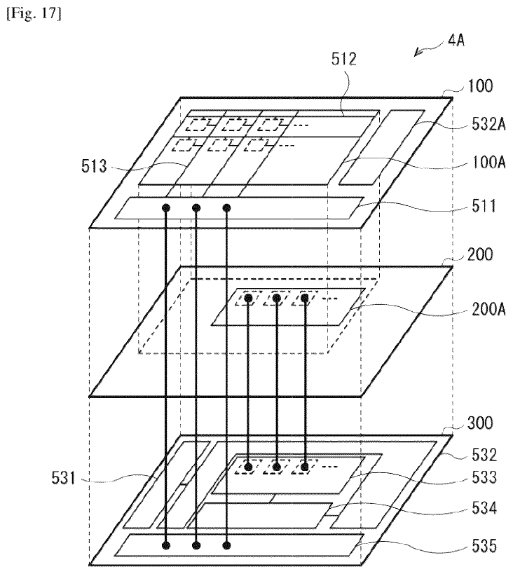

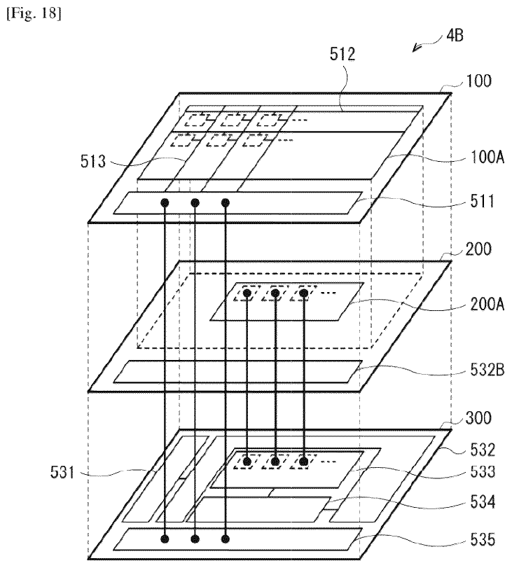

FIG. 17 illustrates an example of a schematic configuration of a photodetector (a photodetector 4A) according to Modification Example 4 of the present disclosure. FIG. 18 illustrates another example of the schematic configuration of a photodetector (a photodetector 4B) according to Modification Example 4 of the present disclosure.

In the above embodiment, an example is illustrated in which the first substrate 100 is provided with the plurality of pixels 110 to acquire two-dimensional image information, the second substrate 200 is provided with the plurality of pixels 210 to acquire depth information, and the third substrate 300 is provided with a logic circuit to process pixel signals outputted from the plurality of pixels 110 and the plurality of pixels 210.

In contrast, in the photodetector 4A of the present modification example, as illustrated in FIG. 17, for example, a signal processing section 532A is provided outside the pixel array section 100A of the first substrate 100, as a portion of the logic circuit provided in the third substrate 300. In the photodetector 4B of the present modification example, as illustrated in FIG. 18, for example, a signal processing section 532B is provided outside the pixel array section 200A of the second substrate 200, as a portion of the logic circuit provided in the third substrate 300.

As described above, in the present modification example, a portion of the logic circuit provided in the third substrate 300 is provided in the first substrate 100 or the second substrate 200. This enables the third substrate 300 to be mounted with, for example, functional elements such as memories and antennas, and functional elements that perform machine learning such as pattern matching and neural networks. Thus, it is possible to provide a more sophisticated photodetector.

### 6. Modification Example 5

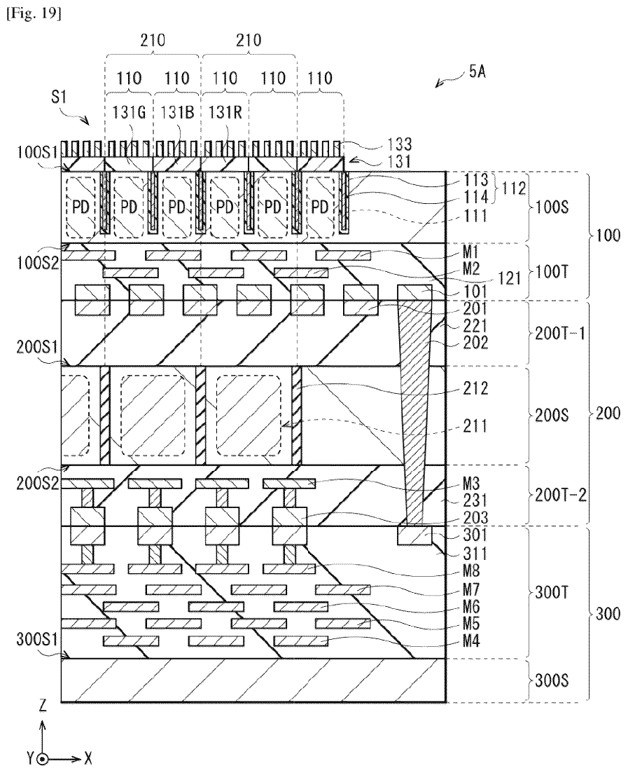

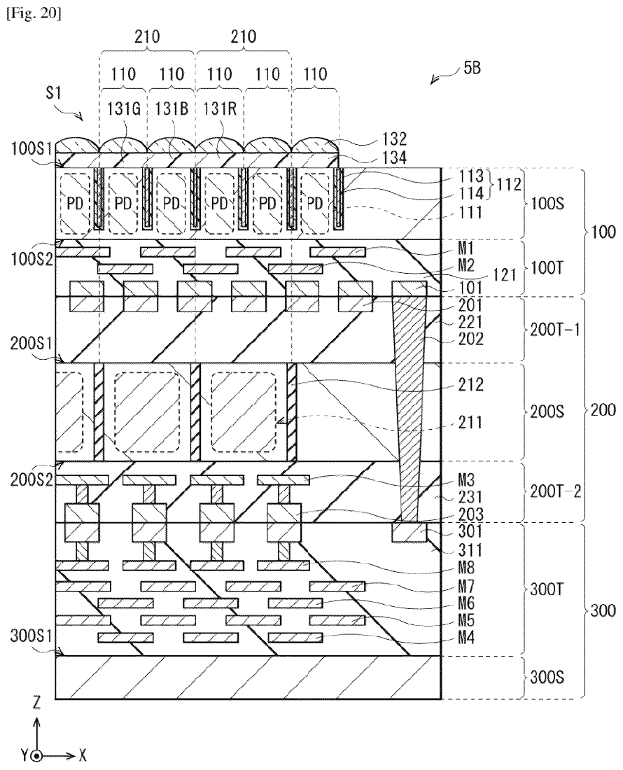

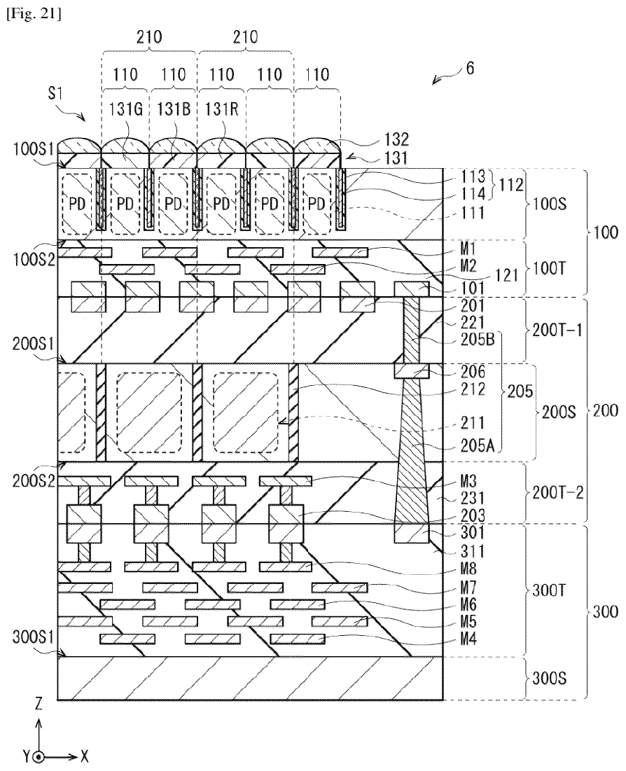

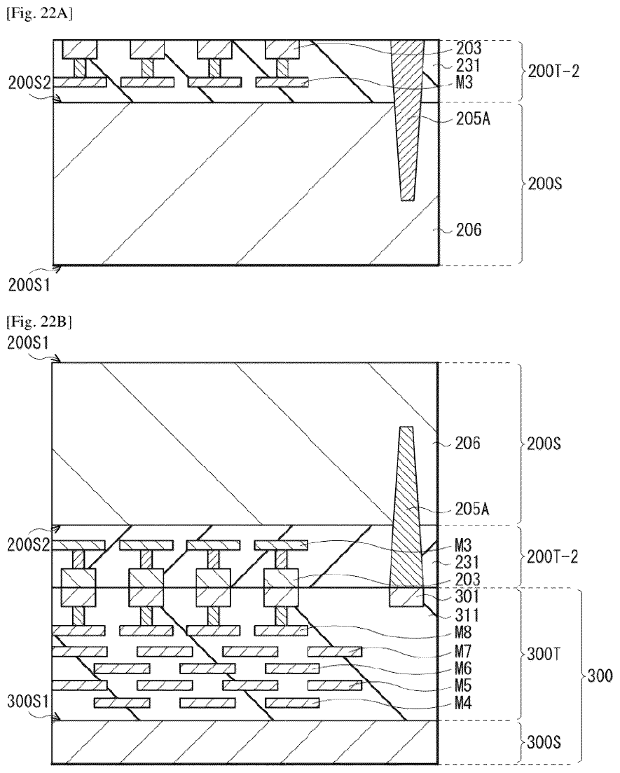

FIG. 19 schematically illustrates an example of a cross-sectional configuration of a photodetector (a photodetector 5A) according to Modification Example 5 of the present disclosure. FIG. 20 schematically illustrates an example of a cross-sectional configuration of a photodetector (a photodetector 5B) according to Modification Example 5 of the present disclosure.

In the above embodiment, the example is illustrated in which the color filters 131 and the on-chip lenses 132 are provided as the optical members on the side of the back surface (the light incident side S1) of the first substrate 100.

In contrast, in the photodetector 5A of the present modification example, meta-lenses 133 formed by patterning the three-dimensional structure is provided, instead of the on-chip lenses 132. In addition, in the photodetector 5B of the present modification example, color routers 134 that demultiplex a predetermined wavelength in the respective pixels 110 are provided, instead of the color filters 131.

As described above, in the present modification example, the color routers 134 and the meta-lenses 133 are provided as the optical members on the side of the back surface (the light incident side S1) of the first substrate 100. Thus, it is possible to obtain the effects similar to those of the above embodiment.

### 7. Modification Example 6

FIG. 21 schematically illustrates an example of a cross-sectional configuration of a photodetector (a photodetector 6) according to Modification Example 6 of the present disclosure.

In the above embodiment, the example is illustrated in which the first substrate 100 and the third substrate 300 are electrically coupled via the through-via 202 that penetrates from the front surface of the wiring layer 200T-1 provided on the side of the back surface 200S1 of the light-receiving layer 200S toward the front surface of the wiring layer 200T-2 provided on the side of the front surface 200S2 of the light-receiving layer 200S.

In contrast, in the photodetector 6 of the present modification example, the first substrate 100 and the third substrate 300 are electrically coupled via a through-via 205 that penetrates from the front surface of the wiring layer 200T-2 provided on the side of the front surface 200S2 of the light-receiving layer 200S toward the front surface of the wiring layer 200T-1 provided on the side of the back surface 200S1 of the light-receiving layer 200S.

The photodetector 6 can be manufactured as follows, for example.

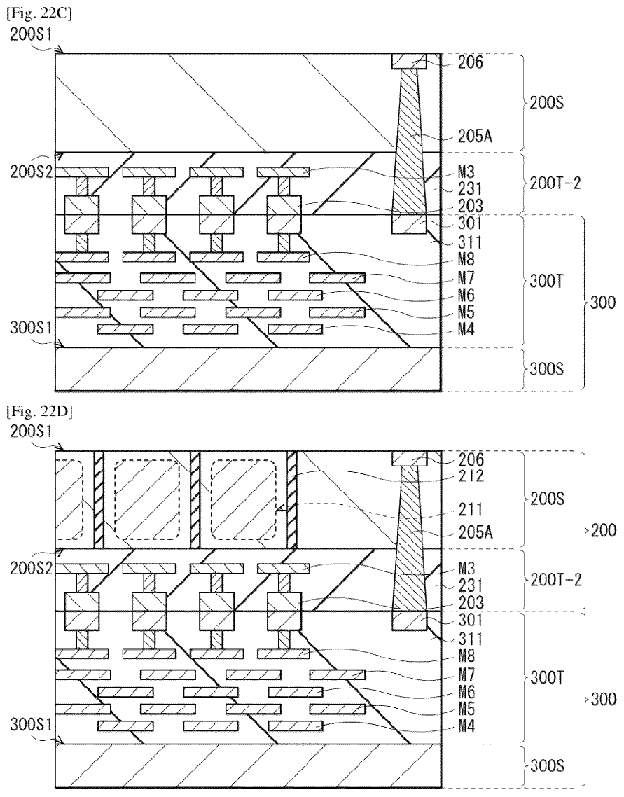

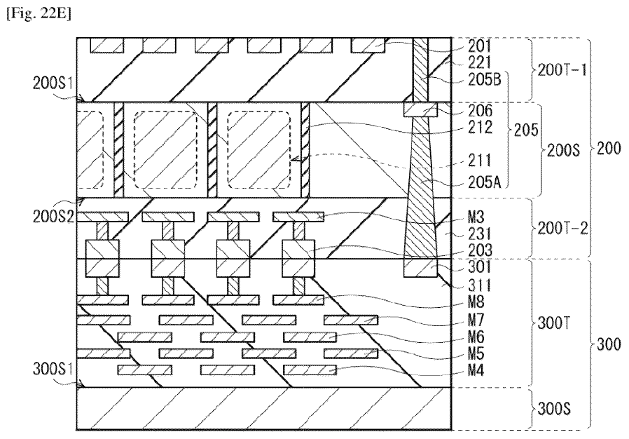

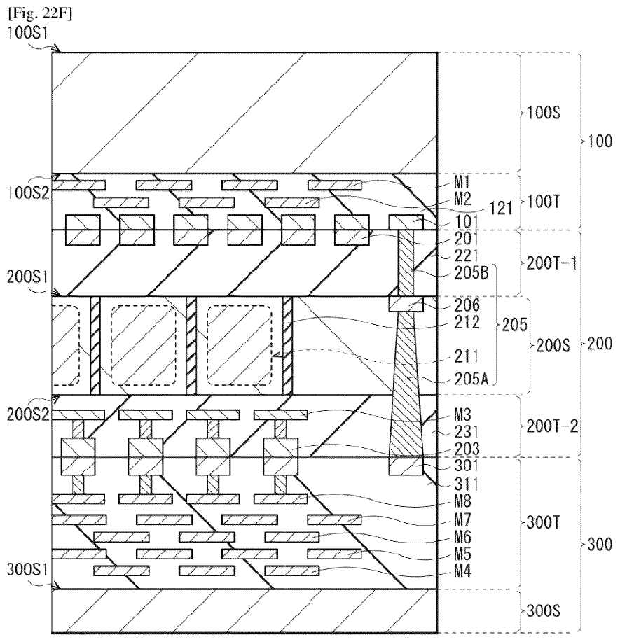

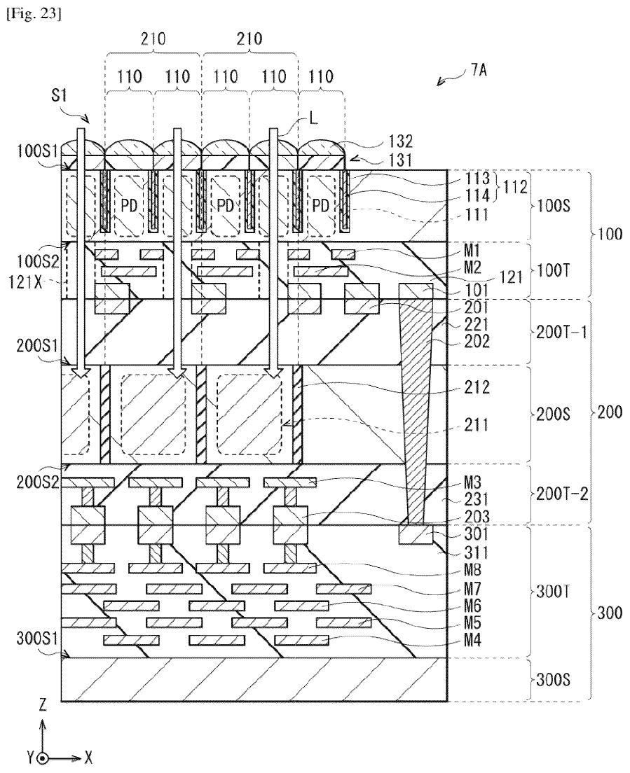

First, the wiring layer 200T-2 is provided on the side of the front surface 200S2 of the light-receiving layer 200S, and then, as illustrated in FIG. 22A, a through-via 205A is formed to extend from the front surface of the wiring layer 200T-2 toward the back surface 200S1 of the light-receiving layer 200S by using, for example, a photolithography technique, etching, sputtering, and the like.

Next, as illustrated in FIG. 22B, the second substrate 200 and the third substrate 300 separately formed are attached to each other to allow the respective wiring layers 200T-2 and 300T to face each other.

Subsequently, for example, the CMP method is used to thin the light-receiving layer 200S, and then, as illustrated in 22C, the through-via 205A is exposed to the back surface 200S1 of the light-receiving layer 200S, and the contact section 206 is formed.

Next, as illustrated in FIG. 22D, a plurality of light-receiving elements and the separation sections 212 are formed in the light-receiving layer 200S.

Subsequently, as illustrated in FIG. 22E, after the wiring layer 200T-1 is formed on the back surface 200S1 of the light-receiving layer 200S by a REOL step, a through-via 205B that penetrates the wiring layer 200T-1 and comes into contact with the contact section 206 is formed, for example, by using a photolithography technique, etching, sputtering, or the like.

Next, as illustrated in FIG. 22F, the first substrate 100 separately formed and the second substrate 200 are hybrid-bonded by attaching together the plurality of contact sections 101 exposed to the front surface of the wiring layer 100T and the plurality of contact sections 201 exposed to the front surface of the wiring layer 200T-1. Thereafter, a plurality of photodiodes PD and the separation sections 112 are formed in the light-receiving layer 100S, and then the color filters 131 and the on-chip lenses 132 are sequentially formed on the back surface 100S1 of the light-receiving layer 100S. Thus, the photodetector 6 illustrated in FIG. 21 is completed.

As described above, in the present modification example, the through-via 204 reaching the third substrate 300 from the back surface 100S1 of the light-receiving layer 100S is provided; the first substrate 100 and the second substrate 200 are electrically coupled to each other, and the first substrate 100 and the third substrate 300 are electrically coupled to each other. This makes it possible to simplify the manufacturing step as compared with the photodetector 1 of the above embodiment in which hybrid bonding is performed twice.

As described above, in the present modification example, the first substrate 100 and the third substrate 300 are electrically coupled to each other via the through-via 205 that penetrates the second substrate 200 from a side of the third substrate 300 toward the first substrate 100. This makes it possible to obtain the effects similar to those of the above embodiment.

### 8. Modification Example 7

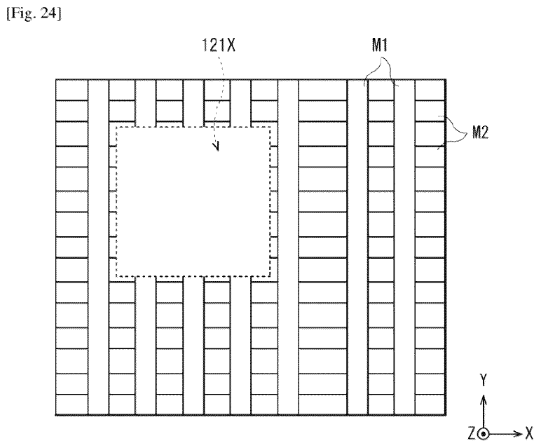

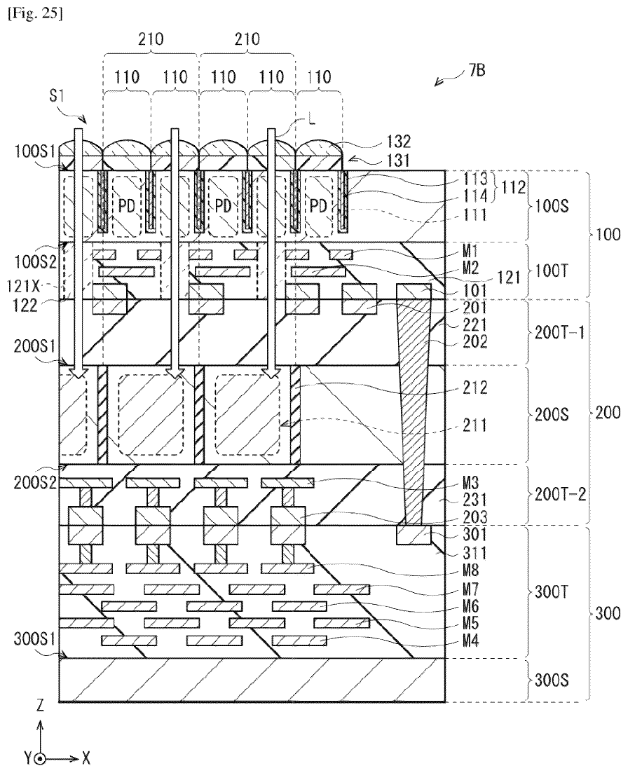

FIG. 23 schematically illustrates an example of a cross-sectional configuration of a photodetector (a photodetector 7A) according to Modification Example 7 of the present disclosure, FIG. 24 schematically illustrates an example of a wiring layout in the wiring layer 100T of the photodetector 7A illustrated in FIG. 23.

In the photodetector 7A of the present modification example, a waveguide 121X in which the wiring layers M1 and M2 are not formed is formed in the layer of the wiring layer 100T above the plurality of pixels 210 arranged in an array in the second substrate 200.

This makes it possible, in the photodetector 7A of the present modification example, to reduce absorption by the wiring layers M1 and M2 and to guide signal light (light L) detected in the plurality of pixels 210 to the light-receiving section 211. Thus, it is possible to improve sensitivity in the second substrate 200 as compared with the photodetector 1 of the above embodiment.

It is to be noted that, as in a photodetector 7B illustrated in FIG. 25, the waveguide 121X may be filled with, for example, a material 122 different from the surrounding interlayer insulating layer 121. Examples of such a material 122 include a resin material having light transmissivity and an organic material that does not absorb a wavelength in a near-infrared region. Alternatively, the material 122 part may be a void. This makes it possible to further reduce absorption of signal light (light L) in the waveguide 121X, and to further improve sensitivity in the second substrate 200.

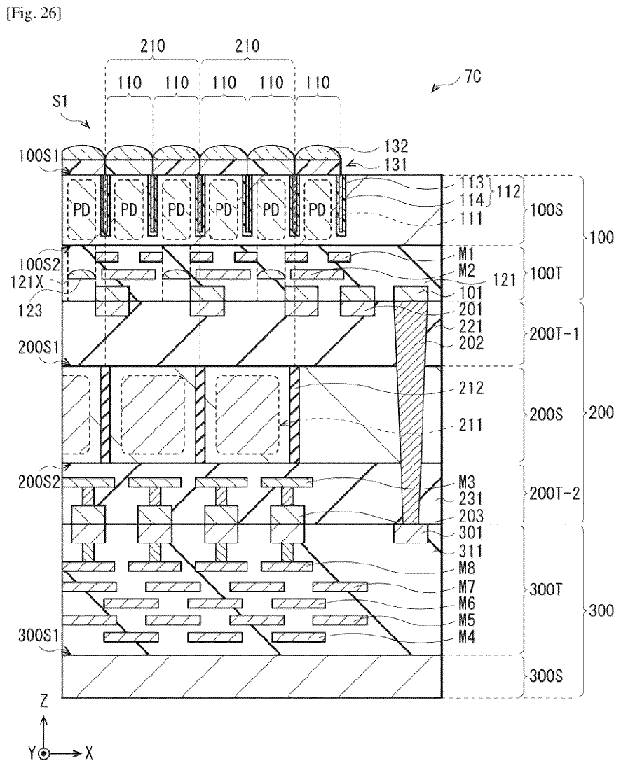

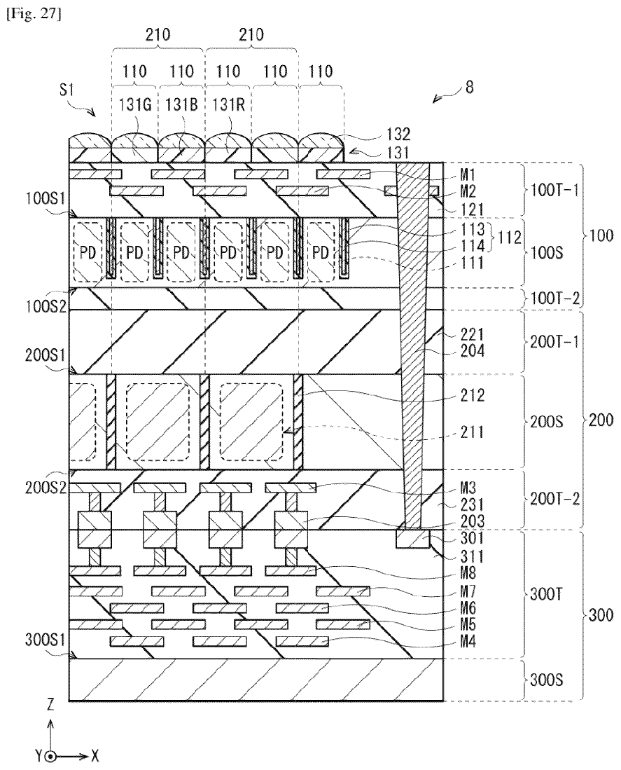

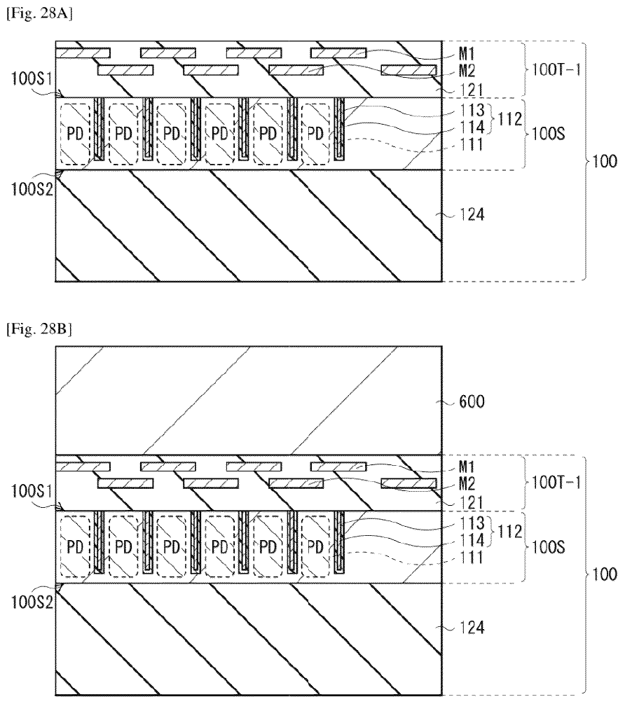

In addition, as in a photodetector 7C illustrated in FIG. 26, an inner lens 123 may be disposed in the waveguide 12X. This enables signal light (light L) to be condensed efficiently on the light-receiving section 211 of the pixel 210, thus making it possible to further improve sensitivity in the second substrate 200.

### 9. Modification Example 8

FIG. 27 schematically illustrates an example of a cross-sectional configuration of a photodetector (a photodetector 8) according to Modification Example 8 of the present disclosure.

In the above embodiment, the wiring layer 100T including the plurality of wiring lines (e.g., the wiring layers M1 and M2) is provided on the side of the front surface 100S2 of the light-receiving layer 100S.

In contrast, in the photodetector 8 of the present modification example, a wiring layer 100T-1 including the plurality of wiring lines (e.g., the wiring layers M1 and M2) is provided on the side of the back surface 100S1 of the light-receiving layer 100S and a wiring layer 100T-2 serving as a bonding layer with the second substrate 200 is provided on the side of the front surface 100S2 of the light-receiving layer 100S.

The photodetector 8 can be manufactured, for example, as follows.

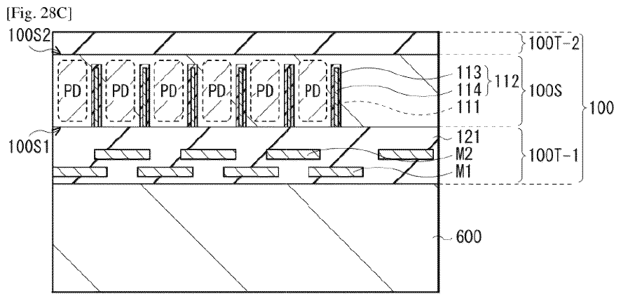

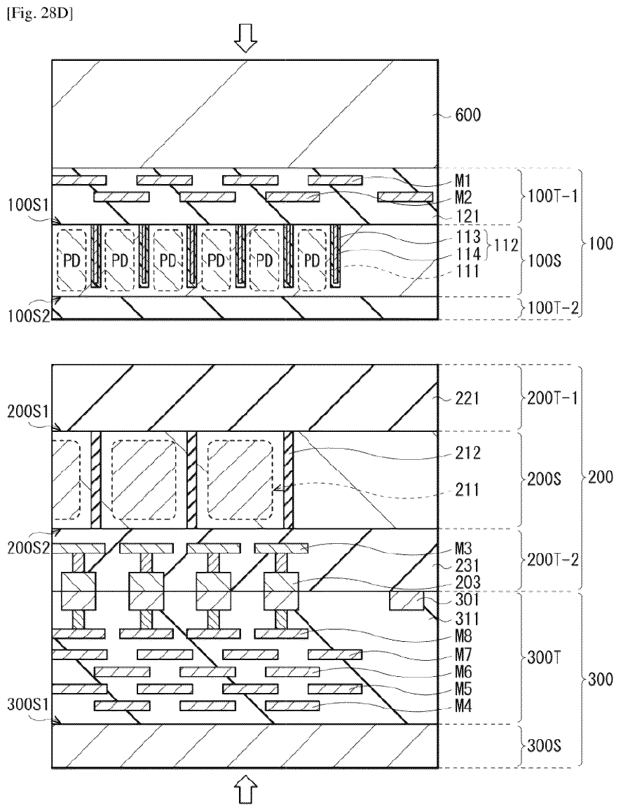

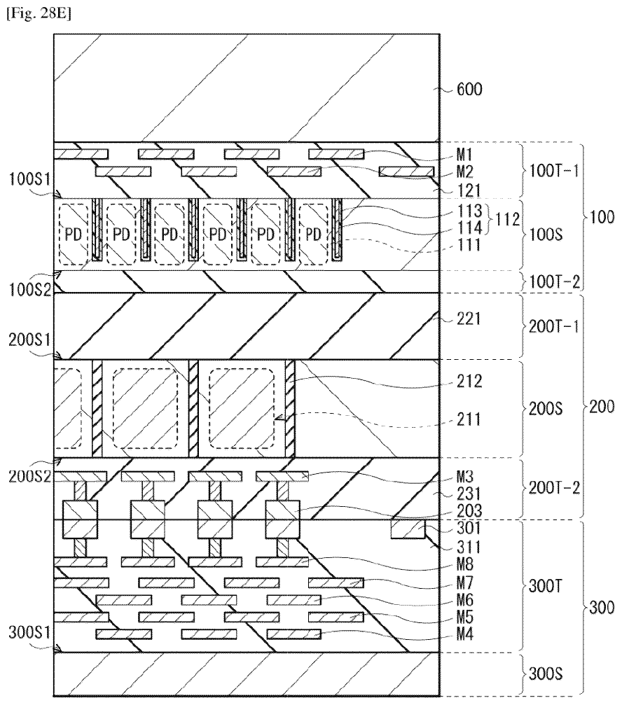

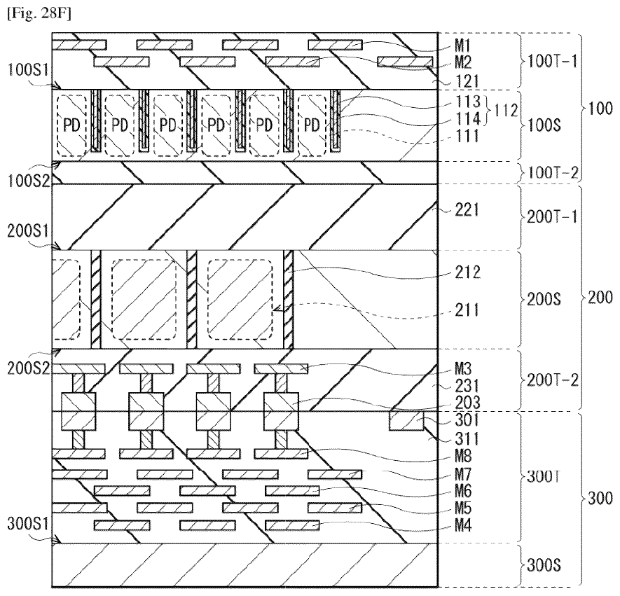

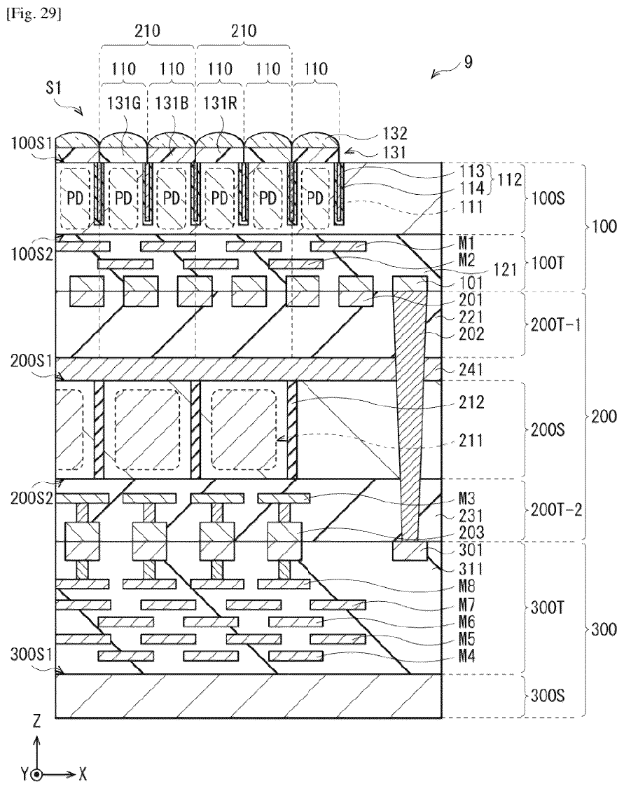

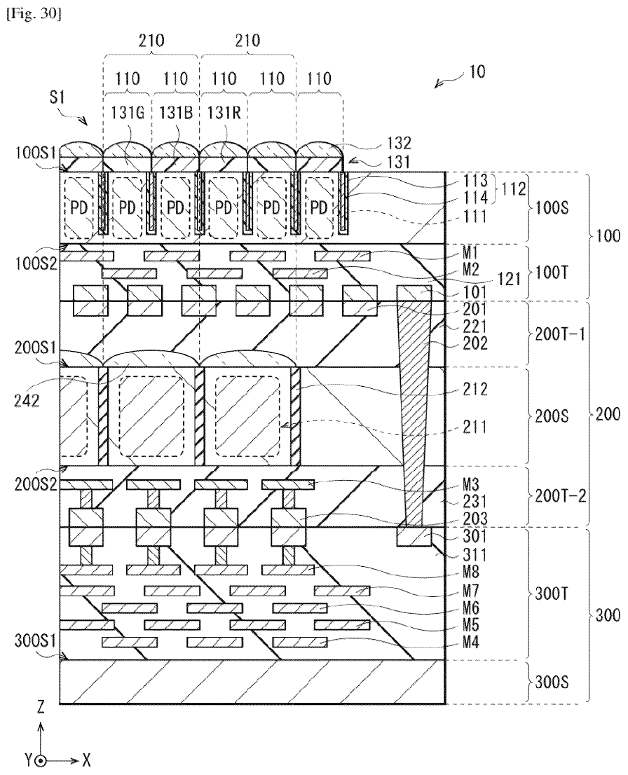

First, as illustrated in FIG. 28A, an insulating layer 124 to be the wiring layer 100T-2 is provided on the side of the front surface 100S2, and the wiring layer 100T-1 is formed, by a BEOL step, on the side of the back surface 100S1 of the light-receiving layer 100S that includes, in the layer, the plurality of photodiodes PD and the separation sections 112.

Next, as illustrated in FIG. 28B, a support substrate 600 is attached onto the wiring layer 100T-1.

Subsequently, as illustrated in FIG. 28C, for example, the insulating layer 124 is thinned by using a CMP method to adjust the wiring layer 100T-1 to have a predetermined thickness.

Next, as illustrated in FIG. 28D, the first substrate 100 and the separately formed second substrate to which the third substrate 300 is hybrid-bonded are disposed to allow the respective wiring layers 100T-2 and 200T-1 to face each other.

Subsequently, as illustrated in FIG. 28E, after the first substrate 100 and the second substrate 200 are attached to each other, the support substrate 600 is removed as illustrated in FIG. 28F. Thereafter, for example, the through-via 204 reaching the contact section 301 from the front surface of the wiring layer 100T-1 is formed by using a photolithography technique, etching, sputtering, or the like, and then the color filters 131 and the on-chip lenses 132 are sequentially formed on the back surface 100S1 of the light-receiving layer 100S. Thus, the photodetector 8 illustrated in FIG. 27 is completed.

As described above, in the photodetector 8 of the present modification example, the wiring layer 100T-1 including the plurality of wiring lines (for example, the wiring layers M1 and M2) is provided on the side of the back surface 100S1 and on the side of the front surface 100S2 of the light-receiving layer 100S. Thus, as compared with the photodetector 1 of the above embodiment, the light-receiving section 111 of the first substrate 100, and the light-receiving section 211 of the second substrate 200 come closer in the stacking direction (Y-axis direction), thus enabling the on-chip lens 132 to focus on a position closer to either the light-receiving section 111 or the light-receiving section 211. Therefore, it is possible to provide a photodetector having high sensitivity.

### 10. Modification Example 9

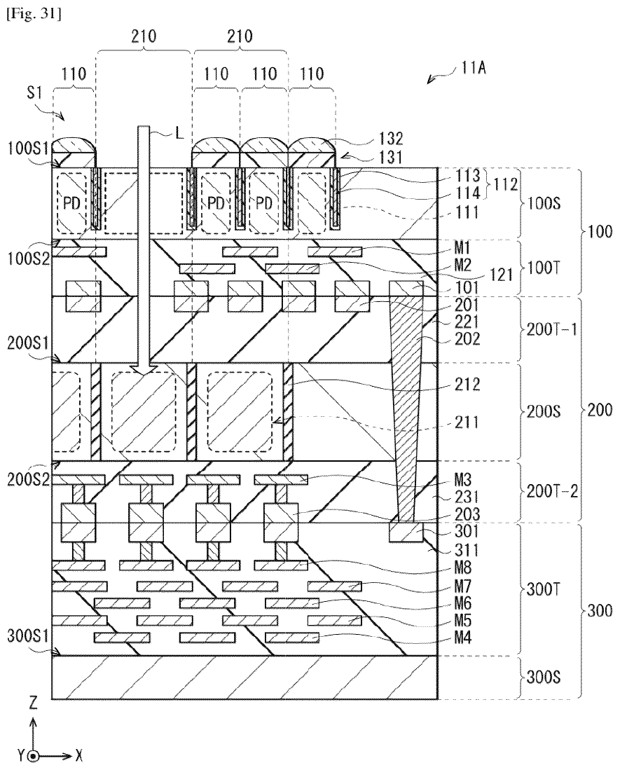

FIG. 29 schematically illustrates an example of a cross-sectional configuration of a photodetector (a photodetector 9) according to Modification Example 9 of the present disclosure.

In the photodetector 9 of the present modification example, a band-pass filter 241 that selectively transmits a predetermined wavelength band including a wavelength of a near-infrared region is provided between the first substrate 100 that detects a wavelength of a visible light region to obtain two-dimensional image information and the second substrate 200 that detects a wavelength of a near-infrared region to obtain depth information.

The band-pass filter 241 includes, for example, a multilayer film in which materials having different refractive indexes are combined, such as silicon oxide (SiO) and amorphous silicon (α-Si), silicon oxide and polysilicon (Poly-Si), silicon oxide and silicon nitride (SiN).

This makes it possible, in the photodetector 9 of the present modification example, to suppress detection of a wavelength other than signal light for distance measurement in the second substrate 200. Thus, it is possible to obtain more accurate depth images, as compared with the photodetector 1 of the above embodiment.

### 11. Modification Example 10

FIG. 30 schematically illustrates an example of a cross-sectional configuration of a photodetector (a photodetector 10) according to Modification Example 10 of the present disclosure.

In the photodetector 10 of the present modification example, for example, an inner lens 242 is provided for each pixel 210 in the wiring layer 200T-1 on the side of the back surface 200S1 of the light-receiving layer 200S.

This makes it possible for the photodetector 10 of the present modification example to efficiently condense signal light (light L) on the light-receiving section 211 of the pixel 210. Thus, it is possible to improve sensitivity in the second substrate 200, as compared with the photodetector 1 of the above embodiment.

### 12. Modification Example 11

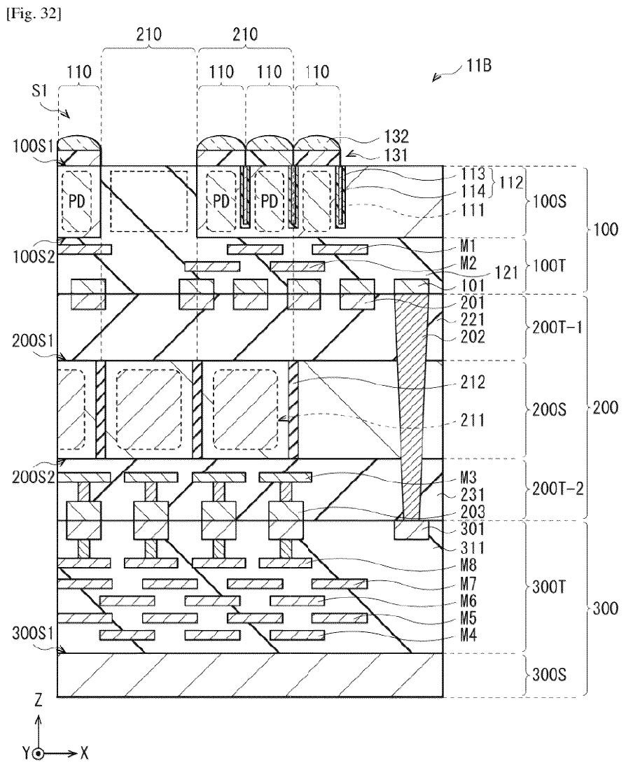

FIG. 31 schematically illustrates an example of a cross-sectional configuration of a photodetector (a photodetector 11A) according to Modification Example 11 of the present disclosure.

In the above embodiment, the example is illustrated in which the plurality of pixels 110 in the first substrate 100 are arranged in an array in the pixel array section 100A without gaps in the row direction and the column direction.

In contrast, in the photodetector 11A of the present modification example, the plurality of pixels 110 arranged in an array in the pixel array section 100A are appropriately omitted, and an opening window 100H is provided above the plurality of pixels 210 arranged in an array on the second substrate 200.

This makes it possible, in the photodetector 11A of the present modification example, to increase signal light (light L) incident on the second substrate 200, and thus to improve sensitivity in the second substrate 200.

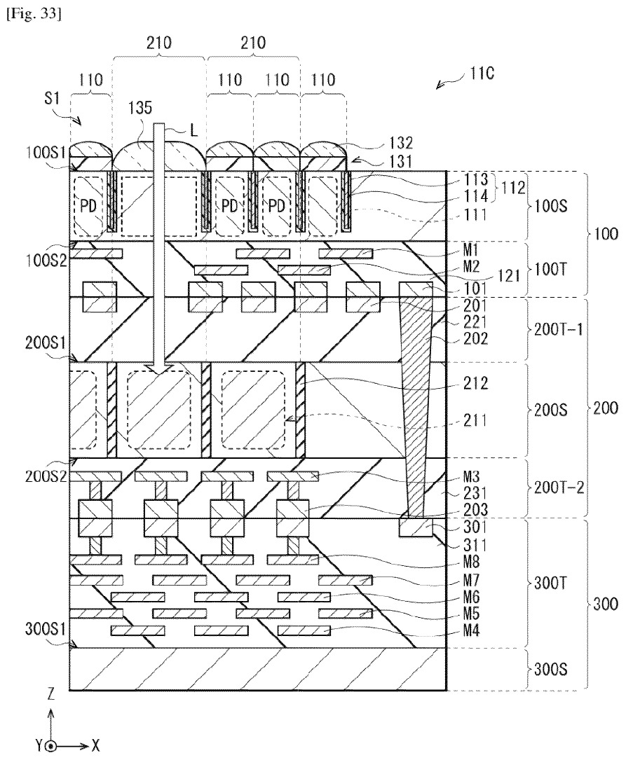

In addition, as in a photodetector 11B illustrated in FIG. 32, the opening window 100H may be filled with a material (e.g., the interlayer insulating layer 121) that is different from the surrounding light-receiving layer 100S. This makes it possible to reduce absorption of the signal light (light L) by the light-receiving layer 200S, and thus to further improve the sensitivity in the second substrate 200.

Furthermore, as in a photodetector 11C illustrated in FIG. 33, the back surface 100S1 of the light-receiving layer 100S in which the opening window 100H is formed may be provided with an on-chip lens 135 that has a different shape from that of the surrounding on-chip lenses 132 and is adjusted to be in focus on the light-receiving section 211. This makes it possible to further increase signal light (light L) to be incident on the second substrate 200, and thus to further improve the sensitivity in the second substrate 200.

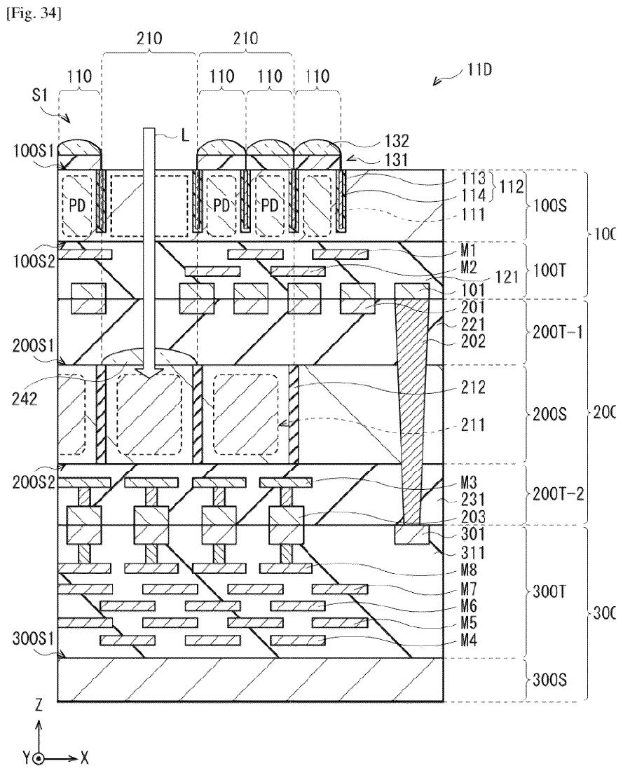

Furthermore, as in a photodetector 11D illustrated in FIG. 34, the pixels 210 above which the opening window 100H is provided may be provided with the inner lens 242 in the wiring layer 200T-1 on the side of the back surface 200S1 of the light-receiving layer 200S. This makes it possible to further increase signal light (light L) that is incident on the second substrate 200, and thus to further improve the sensitivity in the second substrate 200.

### 13. Modification Example 12

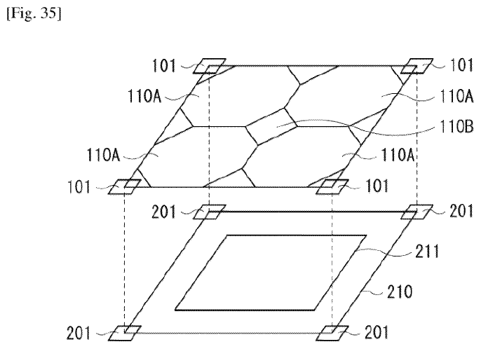

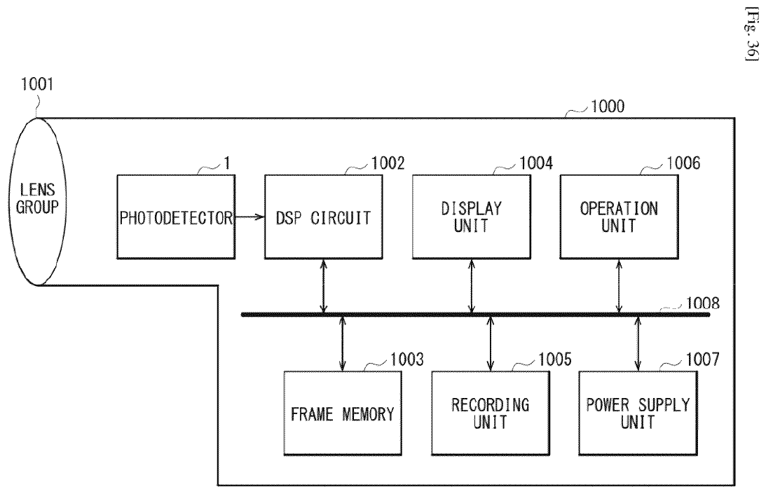

FIG. 35 is a perspective view of an example of a positional relationship between two-dimensional image information acquisition pixels and a depth information acquisition pixel according to Modification Example 12 of the present disclosure.

In the above embodiment, the example is illustrated in which the plurality of pixels 110 configuring the pixel array section 100A in the first substrate 100 have a uniform size; however, this is not limitative. For example, as illustrated in FIG. 35, the pixel array section 100A may be provided with a plurality of pixels 110A and 110B of different sizes. As a result, the first substrate 100 that acquires two-dimensional image information is provided with the pixels (the pixels 110A and 110B) having different amounts of saturated charge (Ws), thus making it possible to enlarge a dynamic range.

### 14. Application Examples

### Application Example 1

The above-described photodetector 1 or the like is applicable, for example, to any type of electronic apparatus with an imaging function including a camera system such as a digital still camera or a video camera, a mobile phone having an imaging function, and the like. FIG. 36 illustrates a schematic configuration of an electronic apparatus 1000.

The electronic apparatus 1000 includes, for example, a lens group 1001, the photodetector 1, a DSP (Digital Signal Processor) circuit 1002, a frame memory 1003, a display unit 1004, a recording unit 1005, an operation unit 1006, and a power supply unit 1007. They are coupled to each other via a bus line 1008.

The lens group 1001 takes in incident light (image light) from a subject, and forms an image on an imaging surface of the photodetector 1. The photodetector 1 converts the amount of incident light formed as an image on the imaging surface by the lens group 1001 into electric signals on a pixel-by-pixel basis, and supplies the DSP circuit 1002 with the electric signals as pixel signals.

The DSP circuit 1002 is a signal processing circuit that processes signals supplied from the photodetector 1. The DSP circuit 1002 outputs image data obtained by processing the signals from the photodetector 1. The frame memory 1003 temporarily holds the image data processed by the DSP circuit 1002.

The display unit 1004 includes, for example, a panel-type display device such as a liquid crystal panel or an organic EL (Electro Luminescence) panel, and records image data of a moving image or a still image captured by the photodetector 1 in a recording medium such as a semiconductor memory or a hard disk.

The operation unit 1006 outputs an operation signal for a variety of functions of the electronic apparatus 1000 in accordance with an operation by a user. The power supply unit 1007 appropriately supplies the DSP circuit 1002, the frame memory 1003, the display unit 1004, the recording unit 1005, and the operation unit 1006 with various kinds of power for operations of these supply targets.

### Application Example 2

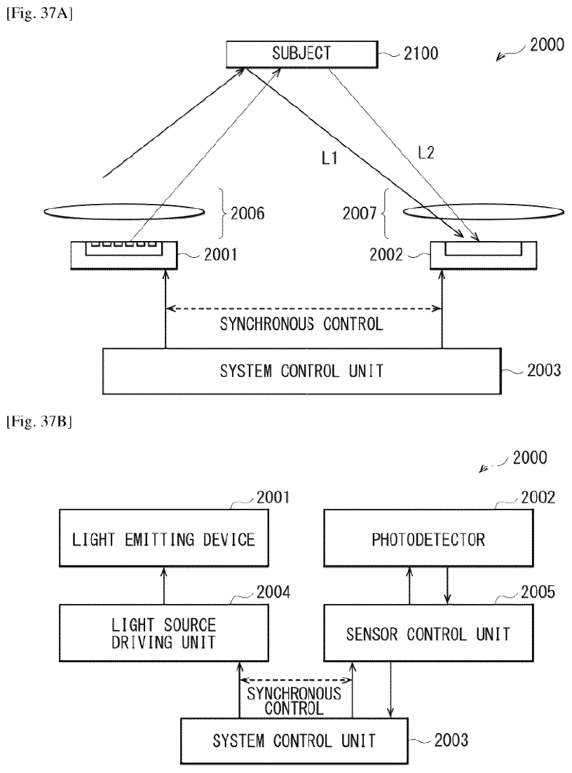

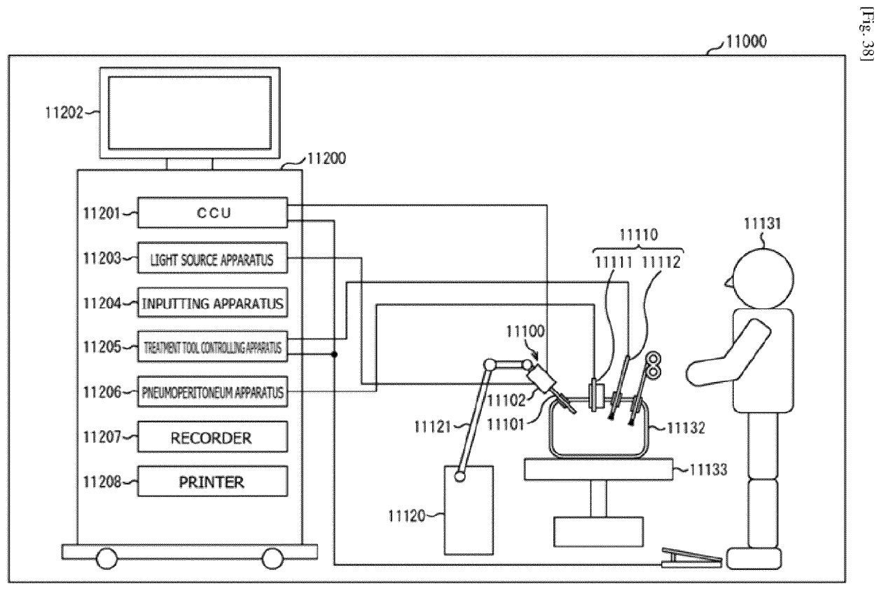

FIG. 37A schematically illustrates an example of an overall configuration of the photodetection system 2000 including the photodetector 1. FIG. 37B illustrates an example of a circuit configuration of the photodetection system 2000. The photodetection system 2000 includes a light-emitting device 2001 as a light source unit that emits infrared light L2, and a photodetector 2002 as a light-receiving unit including a photoelectric conversion element. The photodetector 1 described above can be used as the photodetector 2002. The photodetection system 2000 may further include a system control unit 2003, a light source driving unit 2004, a sensor control unit 2005, a light source side optical system 2006, and a camera side optical system 2007.

The photodetector 2002 is able to detect light L1 and light L2. The light L1 is light of an external environmental light that is reflected at a subject (object to be measured) 2100 (FIG. 37A). The light L2 is light which is emitted by the light-emitting device 2001 and then reflected by the subject 2100. The light L1 is, for example, visible light, and the light L2 is, for example, infrared light. The light L1 can be detected in a photoelectric conversion section in the photodetector 2002, and the light L2 can be detected in a photoelectric conversion region in the photodetector 2002. Image information on the subject 2100 can be obtained from the light L1, and information on a distance between the subject 2100 and the photodetection system 2000 may be obtained from the light L2. For example, the photodetection system 2000 can be mounted on an electronic apparatus such as a smart phone or a mobile body such as a vehicle. The light-emitting device 2001 can be configured by, for example, a semiconductor laser, a surface-emitting semiconductor laser, or a vertical cavity surface emitting laser (VCSEL). As a method of detecting the light L2 emitted from the light-emitting device 2001 using the photodetector 2002, for example, an iTOF method can be adopted; however, this is not limitative. In the iTOF method, it is possible for the photoelectric conversion section to measure the distance to the subject 2100 by, for example, light flight time (Time-of-Flight; TOF). As a method of detecting the light L2 emitted from the light-emitting device 2001 using the photodetector 2002, for example, a structured light method or a stereo vision method can also be adopted. For example, it is possible, in the structured light method, to measure the distance between the photodetection system 2000 and the subject 2100 by projecting a predetermined pattern of light onto the subject 2100 and analyzing the strain state of the pattern. Further, in the stereo vision system, for example, two or more cameras are used, and two or more images of the subject 2100 viewed from two or more different viewpoints are acquired, thereby making it possible to measure the distance between the photodetection system 2000 and the subject. It is to be noted that the light-emitting device 2001 and the photodetector 2002 can be synchronously controlled by the system control section 2003.

### 15. Practical Application Examples

### Example of Practical Application to Endoscopic Surgery System

The technology according to an embodiment of the present disclosure (present technology) is applicable to various products. For example, the technology according to an embodiment of the present disclosure may be applied to an endoscopic surgery system.

FIG. 38 is a view depicting an example of a schematic configuration of an endoscopic surgery system to which the technology according to an embodiment of the present disclosure (present technology) can be applied.

In FIG. 38, a state is illustrated in which a surgeon (medical doctor) 11131 is using an endoscopic surgery system 11000 to perform surgery for a patient 11132 on a patient bed 11133. As depicted, the endoscopic surgery system 11000 includes an endoscope 11100, other surgical tools 11110 such as a pneumoperitoneum tube 11111 and an energy device 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted imo a body cavity of the patient 11132, and a camera head 11102 connected to a proximal end of the lens barrel 11101. In the example depicted, the endoscope 11100 is depicted which includes as a rigid endoscope having the lens barrel 11101 of the hard type. However, the endoscope 11100 may otherwise be included as a flexible endoscope having the lens barrel 11101 of the flexible type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel 11101 by a light guide extending in the inside of the lens barrel 11101 and is irradiated toward an observation target in a body cavity of the patient 11132 through the objective lens. It is to be noted that the endoscope 11100 may be a forward-viewing endoscope or may be an oblique-viewing endoscope or a side-viewing endoscope.

An optical system and an image pickup element are provided in the inside of the camera head 11102 such that reflected light (observation light) from the observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a CCU 11201.

The CCU 11201 includes a central processing unit (CPU), a graphics processing unit (GPU) or the like and integrally controls operation of the endoscope 11100 and a display apparatus 11202. Further, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 includes a light source such as, for example, a light emitting diode (LED) and supplies irradiation light upon imaging of a surgical region to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal distance or the like) by the endoscope 11100.

A treatment tool controlling apparatus 11205 controls driving of the energy device 11112 for cautery or incision of a tissue, sealing of a blood vessel or the like. A pneumoperitoneum apparatus 11206 feeds gas into a body cavity of the patient 11132 through the pneumoperitoneum tube 11111 to inflate the body cavity in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a white light source which includes, for example, an LED, a laser light source or a combination of them. Where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203. Further, in this case, if laser beams from the respective RGB laser light sources are irradiated time-divisionally on an observation target and driving of the image pickup elements of the camera head 11102 are controlled in synchronism with the irradiation timings. Then images individually corresponding to the R, G and B colors can be also picked up time-divisionally. According to this method, a color image can be obtained even if color filters are not provided for the image pickup element.

Further, the light source apparatus 11203 may be controlled such that the intensity of light to be outputted is changed for each predetermined time. By controlling driving of the image pickup element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to irradiate light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 11203 can be configured to supply such narrow-band light and/or excitation light suitable for special light observation as described above.

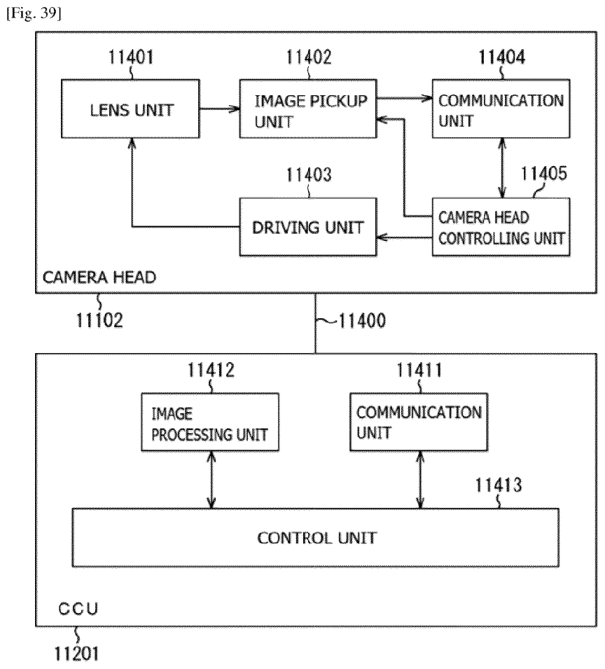

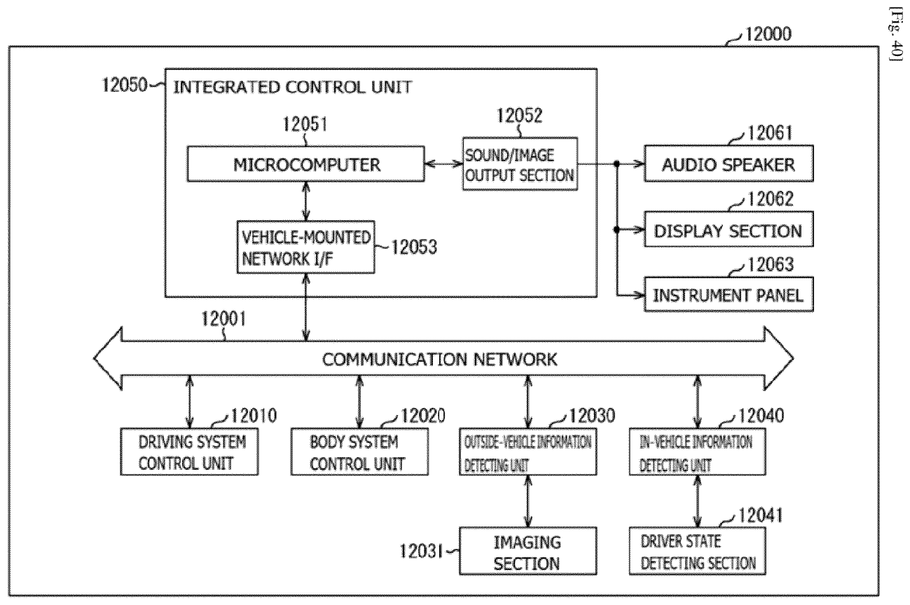

FIG. 39 is a block diagram depicting an example of a functional configuration of the camera head 11102 and the CCU 11201 depicted in FIG. 38.

The camera head 11102 includes a lens unit 11401, an image pickup unit 11402, a driving unit 11403, a communication unit 11404 and a camera head controlling unit 11405. The CCU 11201 includes a communication unit 11411, an image processing unit 11412 and a control unit 11413. The camera head 11102 and the CCU 11201 are connected for communication to each other by a transmission cable 11400.

The lens unit 11401 is an optical system, provided at a connecting location to the lens barrel 11101. Observation light taken in from a distal end of the lens barrel 11101 is guided to the camera head 11102 and introduced into the lens unit 11401. The lens unit 11401 includes a combination of a plurality of lenses including a zoom lens and a focusing lens.

The number of image pickup elements which is included by the image pickup unit 11402 may be one (single-plate type) or a plural number (multi-plate type). Where the image pickup unit 11402 is configured as that of the multi-plate type, for example, image signals corresponding to respective R, G and B are generated by the image pickup elements, and the image signals may be synthesized to obtain a color image. The image pickup unit 11402 may also be configured so as to have a pair of image pickup elements for acquiring respective image signals for the right eye and the left eye ready for three dimensional (3D) display. If 3D display is performed, then the depth of a living body tissue in a surgical region can be comprehended more accurately by the surgeon 11131. It is to be noted that, where the image pickup unit 11402 is configured as that of stereoscopic type, a plurality of systems of lens units 11401 are provided corresponding to the individual image pickup elements.

Further, the image pickup unit 11402 may not necessarily be provided on the camera bead 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405. Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes information relating to image pickup conditions such as, for example, information that a frame rate of a picked up image is designated, information that an exposure value upon image picking up is designated and/or information that a magnification and a focal point of a picked up image are designated.

It is to be noted that the image pickup conditions such as the frame rate, exposure value, magnification or focal point may be designated by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 controls, on the basis of an image signal for which image processes have been performed by the image processing unit 11412, the display apparatus 11202 to display a picked up image in which the surgical region or the like is imaged. Thereupon, the control unit. 11413 may recognize various objects in the picked up image using various image recognition technologies. For example, the control unit 11413 can recognize a surgical tool such as forceps, a particular living body region, bleeding, mist when the energy device 11112 is used and so forth by detecting the shape, color and so forth of edges of objects included in a picked up image. The control unit 11413 may cause, when it controls the display apparatus 11202 to display a picked up image, various kinds of surgery supporting information to be displayed in an overlapping manner with an image of the surgical region using a result of the recognition. Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication or a composite cable ready for both of electrical and optical communications.

Here, while, in the example depicted, communication is performed by wired communication using the transmission cable 11400, the communication between the camera head 11102 and the CCU 11201 may be performed by wireless communication.

The description has been given above of one example of the endoscopic surgery system, to which the technology according to an embodiment of the present disclosure is applicable. The technology according to an embodiment of the present disclosure is applicable to the image pickup unit 11402. Applying the technology according to an embodiment of the present disclosure to the image pickup unit 11402 enables to improve detecting accuracy.

It is to be noted that although the endoscopic surgery system has been described as an example here, the technology according to an embodiment of the present disclosure may be applied to other systems, for example, a microscopic surgery system.

### Practical Application Examples to Mobile Body

The technology according to the present disclosure is applicable to a variety of products. For example, the technology according to the present disclosure may be implemented as a device to be mounted on any type of mobile body such as an automobile, an electric automobile, a hybrid electric automobile, a motorcycle, a bicycle, a personal mobility, an aircraft, a drone, a vessel, a robot, a construction machine, or an agricultural machine (tractor).

FIG. 40 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 40, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 40, an audio speaker 12061, a display section 12062, and an instrument panel 12063 are illustrated as the output device. The display section 12062 may, for example, include at least one of an on-board display and a head-up display.

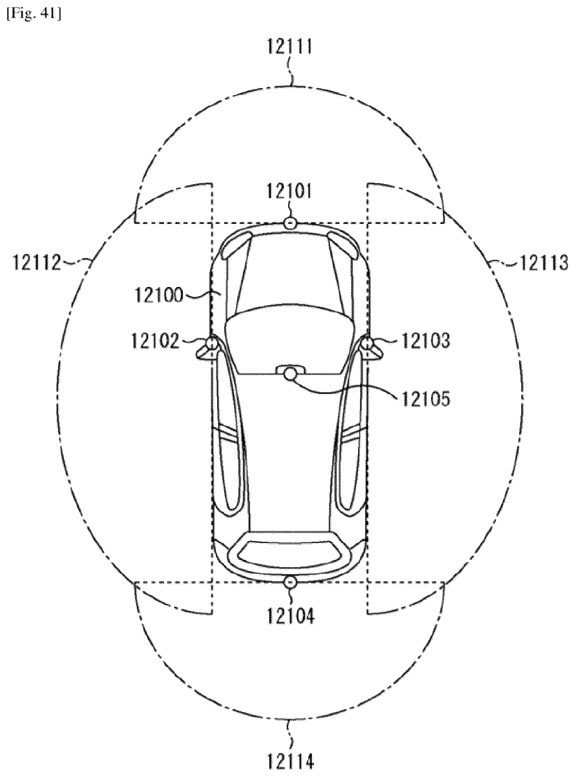

FIG. 41 is a diagram depicting an example of the installation position of the imaging section 12031.

In FIG. 41, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 41 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by super-imposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The description has been given hereinabove of one example of the mobile body control system, to which the technology according to an embodiment of the present disclosure may be applied. The technology according to an embodiment of the present disclosure may be applied to the imaging section 12031 among components of the configuration described above. Specifically, the photodetector according to the above-described embodiment and Modification Examples 1 to 12 (for example, the photodetector 1) is applicable to the imaging section 12031. The application of the technology according to an embodiment of the present disclosure to the imaging section 12031 allows for a high-definition captured image with less noise, thus making it possible to perform highly accurate control utilizing the captured image in the mobile body control system.

Although the present disclosure has been described with reference to the embodiment, Modification Examples 1 to 12, Application Examples, and the Practical Application Examples, the present disclosure is not limited to the above-described embodiment and the like, and various modifications are possible.

It is to be noted that the effects described in the present specification are merely examples. The effects of the present disclosure are not limited to the effects described herein. The present disclosure may have effects other than those described in the specification.

It is to be noted that the present disclosure may also have the following configurations. According to the following configurations, it is possible to acquire two-dimensional image information and depth information by aligning optical axes. In addition, it is possible synchronize the driving of the first sensor pixel and the driving of the second sensor pixel, thus making it possible to suppress color mixing.

(1)
A light detecting device including
a plurality of lenses,
a first substrate including a plurality of image pixels, each image pixel of the plurality of image pixels including a first photodiode configured to output a first signal based on first light that traverses a first portion of the plurality of lenses,
a second substrate including a plurality of depth pixels, each depth pixel of the plurality of depth pixels including a second photodiode configured to output a second signal based on second light that traverses a second portion of the plurality of lenses, the second portion including some or all of the first portion, and
a third substrate including first processing circuitry and second processing circuitry, the first processing circuitry is configured to process the first signal into image data and the second processing circuitry is configured to process the second signal into depth data,
wherein, in a stacking direction, the second substrate is disposed on the third substrate, the first substrate is disposed on the second substrate, and the plurality of lenses is disposed on the first substrate.
   (2)
   The light detecting device of (1), wherein the each image pixel of the plurality of image pixels further includes a transfer transistor, a reset transistor, and an amplification transistor.
   (3)
   The light detecting device of any of (1) and (2), wherein the plurality of image pixels define an imaging area, the plurality of depth pixels define a sensing area, and from a plan view, the imaging area overlaps the sensing area.
   (4)
   The light detecting device of (3), wherein the imaging area is a different size than the sensing area.
   (5)
   The light detecting device of (4), wherein the imaging area is larger than the sensing area, and the imaging area completely overlaps the sensing area.
   (6)
   The light detecting device of (3), wherein the imaging area is the same size as the sensing area.
   (7)
   The light detecting device of any of (1) to (6), wherein light that traverses a single one of the plurality of lenses is received by one of the plurality of image pixels and one of the plurality of depth pixels.
   (8)
   The light detecting device of any of (1) to (7), wherein the second substrate is bonded to and electrically connected to the third substrate by a copper-to-copper (Cu—Cu) bonding, and wherein the electrical connection by the Cu—Cu bonding electrically connects one of the plurality of depth pixels to the second processing circuitry.
   (9)
   The light detecting device of any of (1) to (8), further including a first electrode extending through a via in the second substrate and between the first substrate and the third substrate, the first electrode electrically connecting one of the plurality of image pixels to the first processing circuitry.
   (10)
   The light detecting device of (9), wherein the plurality of image pixels define an imaging area in the first substrate, and the first electrode is electrically connected to the first substrate at a location outside the imaging area.
   (11)
   The light detecting device of (9), wherein the plurality of image pixels define an imaging area in the first substrate, and the first electrode is electrically connected to the first substrate at a location within the imaging area.
   (12)
   The light detecting device of any of (9) to (11), wherein the second substrate includes a first wiring layer facing the first substrate, a second wiring layer facing the third substrate, and a light receiving layer disposed between the first wiring layer and the second wiring layer in the stacking direction, and wherein the first electrode extends from the first wiring layer to the second wiring layer.
   (13)
   The light detecting device of (12), wherein a first end of the first electrode is bonded to a second electrode of the first substrate, and a second end of the first electrode is bonded to a third electrode of the third substrate, the second end being opposite to the first end.
   (14)
   The light detecting device of any of (1) to (13), wherein the second processing circuitry includes a quenching resistor and an inverter.
   (15)
   A light detecting device including
a plurality of lenses,
a first substrate including a plurality of image pixels, each image pixel of the plurality of image pixels including a first photodiode configured to output data first signal based on first light that traverses a first portion of the plurality of lenses,
a second substrate including a plurality of depth pixels, each depth pixel of the plurality of depth pixels including a second photodiode configured to output a second signal based on second light that traverses a second portion of the plurality of lenses, the second portion including some of all of the first portion, and
a third substrate including first processing circuitry and second processing circuitry, the first processing circuitry is configured to process the first signal into image data and the second processing circuitry is configured to process the second signal into depth data,
light that traverses a single one of the plurality of lenses is received by one of the plurality of image pixels and one of the plurality of depth pixels.
   (16)
   The light detecting device of (15), wherein the each image pixel of the plurality of image pixels further includes a transfer transistor, a reset transistor, and an amplification transistor.
   (17)
   The light detecting device of any of (15) and (16), further including a first electrode extending through a via in the second substrate and between the first substrate and the third substrate, the first electrode electrically connecting one of the plurality of image pixels to the first processing circuitry.
   (18)
   The light detecting device of (17), wherein the plurality of image pixels define an imaging area in the first substrate, and the first electrode is electrically connected to the first substrate at a location outside the imaging area.
   (19)
   The light detecting device of (17), wherein the plurality of image pixels define an imaging area in the first substrate, and the first electrode is electrically connected to the first substrate at a location within the imaging area.
   (20)
   The light detecting device of any of (17) to (19), wherein the second substrate includes a first wiring layer facing the first substrate, a second wiring layer facing the third substrate, and a light receiving layer disposed between the first wiring layer and the second wiring layer in the stacking direction, and wherein the first electrode extends from the first wiring layer to the second wiring layer.
   (21)
   The light detecting device of (20), wherein a first end of the first electrode is bonded to a second electrode of the first substrate, and a second end of the first electrode is bonded to a third electrode of the third substrate, the second end being opposite to the first end.
   (22)
   The light detecting device of any of (15) to (21), wherein the second processing circuitry includes a quenching resistor and an inverter.
   (23)
   An electronic apparatus including
a plurality of lenses,
a first substrate including a plurality of image pixels, each image pixel of the plurality of image pixels including a first photodiode configured to output data first signal based on first light that traverses a first portion of the plurality of lenses,
a second substrate including a plurality of depth pixels, each depth pixel of the plurality of depth pixels including a second photodiode configured to output a second signal based on second light that traverses a second portion of the plurality of lenses, the second portion including some or all of the first portion, and
a third substrate including first processing circuitry and second processing circuitry, the first processing circuitry is configured to process the first signal into image data and the second processing circuitry is configured to process the second signal into depth data,
wherein, in a stacking direction, the second substrate is disposed on the third substrate, the first substrate is disposed on the second substrate, and the plurality of lenses is disposed on the first substrate.
   (24)
   The electronic apparatus of claim (23), wherein the each image pixel of the plurality of image pixels further includes a transfer transistor, a reset transistor, and an amplification transistor.
   (25)
   The electronic apparatus of any of (23) and (24), wherein the plurality of image pixels define an imaging area, the plurality of depth pixels define a sensing area, and from a plan view, the imaging area overlaps the sensing area.
   (26)
   The electronic apparatus of (25), wherein the imaging area is a different size than the sensing area.
   (27)
   The electronic apparatus of (26), wherein the imaging area is larger than the sensing area, and the imaging area completely overlaps the sensing area.
   (28)
   The electronic apparatus of (25), wherein the imaging area is the same size as the sensing area.
   (29)
   The electronic apparatus of any of (23) to (28), wherein light that traverses a single one of the plurality of lenses is received by one of the plurality of image pixels and one of the plurality of depth pixels.
   (30)
   The electronic apparatus of any of (23) to (29), wherein the second substrate is bonded to and electrically connected to the third substrate by a copper-to-copper (Cu—Cu) bonding, and wherein the electrical connection by the Cu—Cu bonding electrically connects one of the plurality of depth pixels to the second processing circuitry.
   (31)
   The electronic apparatus of any of (23) to (30), further including a first electrode extending through a via in the second substrate and between the first substrate and the third substrate, the first electrode electrically connecting one of the plurality of image pixels to the first processing circuitry.
   (32)
   The electronic apparatus of (31), wherein the plurality of image pixels define an imaging area in the first substrate, and the first electrode is electrically connected to the first substrate at a location outside the imaging area.
   (33)
   The electronic apparatus of (31), wherein the plurality of image pixels define an imaging area in the first substrate, and the first electrode is electrically connected to the first substrate at a location within the imaging area.
   (34)
   The electronic apparatus of any of (31) to (33), wherein the second substrate includes a first wiring layer facing the first substrate, a second wiring layer facing the third substrate, and a light receiving layer disposed between the first wiring layer and the second wiring layer in the stacking direction, and wherein the first electrode extends from the first wiring layer to the second wiring layer.
   (35)
   The electronic apparatus of (34), wherein a first end of the first electrode is bonded to a second electrode of the first substrate, and a second end of the first electrode is bonded to a third electrode of the third substrate, the second end being opposite to the first end.
   (36)
   The electronic apparatus of any of (23) to (35), wherein the second processing circuitry includes a quenching resistor and an inverter.

### (B-1)

A photodetector including:
a first substrate including a first light-receiving layer in which a plurality of first sensor pixels that acquire two-dimensional image information are arranged in an array;
a second substrate stacked on the first substrate, and including a second light-receiving layer in which a plurality of second sensor pixels that acquire depth image information are arranged in an array to be superimposed on the plurality of first sensor pixels; and
a third substrate stacked on the second substrate, and including a logic circuit that processes pixel signals outputted from the plurality of first sensor pixels and the plurality of second sensor pixels.

### (B-2)

The photodetector according to (1), in which
the first light-receiving layer is provided with a first light-receiving section in each of the plurality of first sensor pixels, and the second light receiving layer is provided with a second light-receiving section in each of the plurality of second sensor pixels, and signal light that is detected in the second light-receiving section is incident through the first light-receiving section.

### (B-3)

The photodetector according to (1) or (2), in which the second substrate and the third substrate are electrically coupled to each other by hybrid bonding.

### (B-4)

The photodetector according to any one of (1) to (3), in which the first substrate and the second substrate are electrically coupled to each other by hybrid bonding.

### (B-5)

The photodetector according to any one of (1) to (4), in which
the first light-receiving layer has a first surface serving as a light incident surface and a second surface on a side opposite to a side of the first surface, and
the first substrate and the second substrate are electrically coupled to each other by a through-wiring line penetrating the second light-receiving layer from the first surface.

### (B-6)

The photodetector according to any one of (1) to (5), in which
the first light-receiving layer has a first surface serving as a light incident surface and a second surface on a side opposite to a side of the first surface, and
the first substrate and the third substrate are electrically coupled to each other by a through-wiring line penetrating the second light-receiving layer from the first surface and reaching the third substrate.

### (B-7)

The photodetector according to (6), in which signals outputted from the plurality of first sensor pixels are transmitted to the logic circuit through the through-wiring line.

### (B-8)

The photodetector according to any one of (3) to (7), in which signals outputted from the plurality of second sensor pixels are transmitted to the logic circuit through the hybrid bonding.

### (B-9)

The photodetector according to any one of (1) to (8), in which a first array region in which the plurality of first sensor pixels are arranged in an array is larger than a second array region in which the plurality of second sensor pixels are arranged in an array.

### (B-10)

The photodetector according to (9), in which the first array region includes the second array region in a plan view.

### (B-11)

The photodetector according to any one of (1) to (10), in which the plurality of first sensor pixels are arranged without gaps.

### (B-12)

The photodetector according to any one of (1) to (11), in which a pixel size of each of the plurality of first sensor pixels is smaller than a pixel size of each of the plurality of second sensor pixels.

### (B-13)

The photodetector according to any one of (1) to (12), in which one of the second sensor pixels is superimposed in a stacking direction on the plurality of first sensor pixels.

### (B-14)

The photodetector according to any one of (1) to (13), in which one of the second sensor pixels is superimposed in a stacking direction on four of the first sensor pixels arranged in two rows by two columns.

### (B-15)

The photodetector according to any one of (1) to (14), in which a pitch of pixel blocks each including the plurality of first sensor pixels substantially coincides with a pixel pitch of the plurality of second sensor pixels in a plan view.

### (B-16)

The photodetector according to (15), in which
the first substrate and the second substrate are electrically coupled to each other by hybrid bonding, and
a plurality of junctions forming the hybrid bonding are disposed between the plurality of second sensor pixels adjacent to each other.

### (B-17)

The photodetector according to any one of (1) to (16), in which a portion of the logic circuit is provided in the first substrate.

### (B-18)

The photodetector according to any one of (1) to (17), in which a portion of the logic circuit is provided in the second substrate.

### (B-19)

The photodetector according to any one of (2) to (18), in which
the first light-receiving layer has a first surface serving as a light incident surface and a second surface on a side opposite to a side of the first surface, and
the first substrate further includes, on the side of the second surface, a first wiring layer including in the layer a waveguide of signal light that is detected in the second light-receiving section.

### (B-20)

The photodetector according to (19), in which an inner lens that condenses the signal light on the plurality of second sensor pixels is disposed in the waveguide.

### (B-21)

The photodetector according to any one of (2) to (20), in which
the second substrate further includes a second wiring layer on a side of a surface of the second light-receiving layer facing the first substrate, and
an inner lens that condenses the signal light on the plurality of second sensor pixels is disposed in the second wiring layer.

### (B-22)

The photodetector according to any one of (2) to (21), in which a photodiode including a semiconductor is formed in the first light-receiving section.

### (B-23)

The photodetector according to any one of (1) to (22), in which a single photon avalanche diode or an avalanche photodiode including a semiconductor is formed in the second light-receiving section.

### (B-24)

The photodetector according to any one of (1) to (23), in which the first substrate further includes an optical member on a light incident side.

### (B-25)

The photodetector according to (24), in which a color filter or a color router is included as the optical member.

### (B-26)

The photodetector according to (24) or (25), in which a microlens or a meta-lens is included as the optical member.

### (B-27)

The photodetector according to any one of (1) to (26), further including a band-pass filter that selectively transmits a predetermined wavelength band between the first substrate and the second substrate.

### (B-28)

An electronic apparatus including a photodetector,
the photodetector including
a first substrate including a first light-receiving layer in which a plurality of first sensor pixels that acquire two-dimensional image information are arranged in an array,
a second substrate stacked on the first substrate, and including a second light-receiving layer in which a plurality of second sensor pixels that acquire depth image information are arranged in an array to be superimposed on the plurality of first sensor pixels, and
a third substrate stacked on the second substrate and including a logic circuit that processes pixel signals outputted from the plurality of first sensor pixels and the plurality of second sensor pixels.

### (B-29)

A photodetector including:
a first substrate including a first light-receiving layer in which a plurality of first sensor pixels that acquire two-dimensional image information are arranged without gaps in an array;
a second substrate stacked on the first substrate, and including a second light-receiving layer in which a plurality of second sensor pixels that acquire depth image information are arranged in an array to be superimposed on the plurality of first sensor pixels; and
a third substrate stacked on the second substrate and including a logic circuit that controls driving of the plurality of first sensor pixels and the plurality of second sensor pixels.

### REFERENCE SIGNS LIST

1, 2, 3, 4A, 4B, 5A, 5B, 6, 7A, 7B, 7C, 8, 9, 10, 11A, 11B, 11C, 11D photodetector
100 first substrate
100A, 200A pixel array section
100S, 200S light-receiving layer
100T, 100T-1, 100T-2, 200T-1, 200T-2, 300T wiring line
101, 201, 203, 206, 301 contact section
110, 110A, 110B, 210 pixel
111, 211 light-receiving section
112, 212 separation section
113, 212A light-blocking film
114, 212B insulating film
121, 221, 231, 311 interlayer insulating layer
123, 242 inner lens
124 insulating layer
131, 131R, 131G, 131G, 131B, 131Y color filter
132, 135 on-chip lens
133 meta-lens
134 color router
202, 204, 205, 20A, 205B through-via
213 p-type semiconductor region (p)
214 multiplication section
214A n-type semiconductor region (n⁺)
214B p-type semiconductor region (p⁺)
215, 216 contact layer
217 fixed charge film
300S semiconductor layer
511, 525 readout section
531 input/output section
532 signal processing section
533 pixel circuit section
534 histogram generating section
600 support substrate
TR transfer transistor
RST reset transistor
AMP amplification transistor
SEL selection transistor
FD floating diffusion
M1, M2, M3, M4, M5, M6, M7, M8 wiring layer
S1 . . . light incident side

1. A light detecting device comprising:
a plurality of lenses;
a first substrate including a plurality of image pixels, each image pixel of the plurality of image pixels including a first photodiode configured to output a first signal based on first light that traverses a first portion of the plurality of lenses;
a second substrate including a plurality of depth pixels, each depth pixel of the plurality of depth pixels including a second photodiode configured to output a second signal based on second light that traverses a second portion of the plurality of lenses, the second portion including some or all of the first portion; and
a third substrate including first processing circuitry and second processing circuitry, the first processing circuitry is configured to process the first signal into image data and the second processing circuitry is configured to process the second signal into depth data, wherein, in a stacking direction, the second substrate is disposed on the third substrate, the first substrate is disposed on the second substrate, and the plurality of leases is disposed on the first substrate.

2. The light detecting device of claim 1, wherein the each image pixel of the plurality of image pixels further includes a transfer transistor, a reset transistor, and an amplification transistor.

3. The light detecting device of claim 1, wherein
the plurality of image pixels define an imaging area,
the plurality of depth pixels define a sensing area, and
from a plan view, the imaging area overlaps the sensing area.

4. The light detecting device of claim 3, wherein the imaging area is a different size than the sensing area.

5. The light detecting device of claim 4, wherein the imaging area is larger than the sensing area, and the imaging area completely overlaps the sensing area.

6. The light detecting device of claim 3, wherein the imaging area is the same size as the sensing area.

7. The light detecting device of claim 1, wherein
light that traverses a single one of the plurality of lenses is received by one of the plurality of image pixels and one of the plurality of depth pixels.

8. The light detecting device of claim 1, wherein the second substrate is bonded to and electrically connected to the third substrate by a copper-to-copper (Cu—Cu) bonding, and wherein the electrical connection by the Cu—Cu bonding electrically connects one of the plurality of depth pixels to the second processing circuitry.

9. The light detecting device of claim 1, further comprising:
a first electrode extending through a via in the second substrate and between the first substrate and the third substrate, the first electrode electrically connecting one of the plurality of image pixels to the first processing circuitry.

10. The light detecting device of claim 9, wherein the plurality of image pixels define an imaging area in the first substrate, and the first electrode is electrically connected to the first substrate at a location outside the imaging area.

11. The light detecting device of claim 9, wherein the plurality of image pixels define an imaging area in the first substrate, and the first electrode is electrically connected to the first substrate at a location within the imaging area.

12. The light detecting device of claim 9, wherein the second substrate includes a first wiring layer facing the first substrate, a second wiring layer facing the third substrate, and a light receiving layer disposed between the first wiring layer and the second wiring layer in the stacking direction, and wherein the first electrode extends from the first wiring layer to the second wiring layer.

13. The light detecting device of claim 12, wherein
a first end of the first electrode is bonded to a second electrode of the first substrate, and
a second end of the first electrode is bonded to a third electrode of the third substrate, the second end being opposite to the first end.

14. The light detecting device of claim 1, wherein
the second processing circuitry includes a quenching resistor and an inverter.

15. A light detecting device comprising:
a plurality of lenses;
a first substrate including a plurality of image pixels, each image pixel of the plurality of image pixels including a first photodiode configured to output data first signal based on first light that traverses a first portion of the plurality of lenses;
a second substrate including a plurality of depth pixels, each depth pixel of the plurality of depth pixels including a second photodiode configured to output a second signal based on second light that traverses a second portion of the plurality of lenses, the second portion including some or all of the first portion; and
a third substrate including first processing circuitry and second processing circuitry, the first processing circuitry is configured to process the first signal into image data and the second processing circuitry is configured to process the second signal into depth data, light that traverses a single one of the plurality of lenses is received by one of the plurality of image pixels and one of the plurality of depth pixels.

16. The light detecting device of claim 15, wherein the each image pixel of the plurality of image pixels further includes a transfer transistor, a reset transistor, and an amplification transistor.

17. The light detecting device of claim 15, further comprising:
a first electrode extending through a via in the second substrate and between the first substrate and the third substrate, the first electrode electrically connecting one of the plurality of image pixels to the first processing circuitry.

18. The light detecting device of claim 17, wherein the plurality of image pixels define an imaging area in the first substrate, and the first electrode is electrically connected to the first substrate at a location outside the imaging area.

19. The light detecting device of claim 17, wherein the plurality of image pixels define an imaging area in the first substrate, and the first electrode is electrically connected to the first substrate at a location within the imaging area.

20. The light detecting device of claim 17, wherein the second substrate includes a first wiring layer facing the first substrate, a second wiring layer facing the third substrate, and a light receiving layer disposed between the first wiring layer and the second wiring layer in the stacking direction, and wherein the first electrode extends from the first wiring layer to the second wiring layer.

21. The light detecting device of claim 20, wherein
a first end of the first electrode is bonded to a second electrode of the first substrate, and
a second end of the first electrode is bonded to a third electrode of the third substrate, the second end being opposite to the first end.

22. The light detecting device of claim 15, wherein
the second processing circuitry includes a quenching resistor and an inverter.

23. An electronic apparatus comprising:
a plurality of lenses;
a first substrate including a plurality of image pixels, each image pixel of the plurality of image pixels including a first photodiode configured to output data first signal based on first light that traverses a first portion of the plurality of lenses;
a second substrate including a plurality of depth pixels, each depth pixel of the plurality of depth pixels including a second photodiode configured to output a second signal based on second light that traverses a second portion of the plurality of lenses, the second portion including some or all of the first portion; and
a third substrate including first processing circuitry and second processing circuitry, the first processing circuitry is configured to process the first signal into image data and the second processing circuitry is configured to process the second signal into depth data, wherein, in a stacking direction, the second substrate is disposed on the third substrate, the first substrate is disposed on the second substrate, and the plurality of lenses is disposed on the first substrate.

24. The electronic apparatus of claim 23, wherein the each image pixel of the plurality of image pixels further includes a transfer transistor, a reset transistor, and an amplification transistor.

25. The electronic apparatus of claim 23, wherein
the plurality of image pixels define an imaging area,
the plurality of depth pixels define a sensing area, and
from a plan view, the imaging area overlaps the sensing area.

26. The electronic apparatus of claim 25, wherein the imaging area is a different size than the sensing area.

27. The electronic apparatus of claim 26, wherein the imaging area is larger than the sensing area, and the imaging area completely overlaps the sensing area.

28. The electronic apparatus of claim 25, wherein the imaging area is the same size as the sensing area.

29. The electronic apparatus of claim 23, wherein
light that traverses a single one of the plurality of lenses is received by one of the plurality of image pixels and one of the plurality of depth pixels.

30. The electronic apparatus of claim 23, wherein the second substrate is bonded to and electrically connected to the third substrate by a copper-to-copper (Cu—Cu) bonding, and wherein the electrical connection by the Cu—Cu bonding electrically connects one of the plurality of depth pixels to the second processing circuitry.

31. The electronic apparatus of claim 23, further comprising:
a first electrode extending through a via in the second substrate and between the first substrate and the third substrate, the first electrode electrically connecting one of the plurality of image pixels to the first processing circuitry.

32. The electronic apparatus of claim 31, wherein the plurality of image pixels define an imaging area in the first substrate, and the first electrode is electrically connected to the first substrate at a location outside the imaging area.

33. The electronic apparatus of claim 31, wherein the plurality of image pixels define an imaging area in the first substrate, and the first electrode is electrically connected to the first substrate at a location within the imaging area.

34. The electronic apparatus of claim 31, wherein the second substrate includes a first wiring layer facing the first substrate, a second wiring layer facing the third substrate, and a light receiving layer disposed between the first wiring layer and the second wiring layer in the stacking direction, and wherein the first electrode extends from the first wiring layer to the second wiring layer.

35. The electronic apparatus of claim 34, wherein
a first end of the first electrode is bonded to a second electrode of the first substrate, and
a second end of the first electrode is bonded to a third electrode of the third substrate, the second end being opposite to the first end.

36. The electronic apparatus of claim 23, wherein
the second processing circuitry includes a quenching resistor and an inverter.
